(19) United States
(12) Patent Application Publication
(10) Pub. No.: US 2026/0109876 A1
(43) Pub. Date: Apr. 23, 2026

(54) BIODEGRADABLE POLYMER BLEND AND USE THEREOF

(71) Applicant: BASF SE, Ludwigshafen am Rhein (DE)

(72) Inventors: Kai Oliver SIEGENTHALER, Ludwigshafen am Rhein (DE); Jerome LOHMANN, Ludwigshafen am Rhein (DE); Michael Bernhard SCHICK, Ludwigshafen am Rhein (DE); Timo Benjamin WITT, Ludwigshafen am Rhein (DE); Frank BLOSS, Ludwigshafen am Rhein (DE); Andreas LUDWIG, Ludwigshafen am Rhein (DE)

(21) Appl. No.: 19/117,984

(22) PCT Filed: Oct. 4, 2023
(86) PCT No.: PCT/EP2023/077462

§ 371 Date: Apr. 3, 2025

(30) Foreign Application Priority Data
Oct. 5, 2022 (EP) 22199867.7

(51) Int. Cl. C09D 167/04; C08L 67/04; D21H 19/28; D21H 23/46

(52) U.S. Cl. CPC C09D 167/04; C08L 67/04; D21H 19/28; D21H 23/46; C08L 2201/06; C08L 2205/025; C08L 2205/03

(57) ABSTRACT

The present invention relates to a biodegradable polymer blend based on a biodegradable aliphatic aromatic polyester and/or aliphatic polyester comprising: The blend comprises—10 to 80% by weight, based on the total weight of polyester a), polymer b) and polycaprolactone c), of at least one biodegradable polyester a) selected from the group consisting of aliphatic-aromatic polyesters, aliphatic polyesters, which are different from polymers b) and c), and mixtures thereof;—18 to 88% by weight, based on the total weight of polyester a), polymer b) and polycaprolactone c), of at least one polymer b), selected from the group consisting of polyhydroxyalkanoates, polylactides, polyglycolic acid and mixtures thereof;—2 to 72% by weight, based on the total weight of polyester a), polymer b) and polycaprolactone c), of at least one polycaprolactone c) having a viscosity number of at least 110 ml/g, in particular at least 150 ml/g, preferably at least 200 ml/g, especially at least 250 ml/g, as determined according to DIN 53728-3:1985-1; wherein the total weight of polyester a), polymer b) and polycaprolactone c) is at least 50% by weight, based on the total weight of the blend. The present invention relates to the use of the blend for coating substrates or for producing a rigid packaging article, to a mono-layered or multi-layered film comprising at least one layer comprising a biodegradable polymer blend, as defined hereinafter and to a process for coating a substrate layer. The present invention also relates to a laminate comprising at least one mono-layered or multi-layered film comprising at least one layer comprising a biodegradable polymer blend, as defined hereinafter, and to packaging materials.

The present invention relates to a biodegradable polymer blend based on a biodegradable aliphatic aromatic polyester and/or aliphatic polyester, to the use thereof for coating substrates or for producing a rigid packaging article, to a mono-layered or multi-layered film comprising at least one layer comprising a biodegradable polymer blend, as defined hereinafter and to a process for coating a substrate layer.

The present invention also relates to a laminate comprising at least one mono-layered or multi-layered film comprising at least one layer comprising a biodegradable polymer blend, as defined hereinafter, and to packaging materials.

### BACKGROUND ON THE INVENTION

Extrusion coating, extrusion lamination and adhesive lamination are standard and versatile coating techniques to apply a polymer film onto a substrate such as paper, paperboard, corrugated fiberboard, aluminum foils, cellulose, non-wovens, or plastic films. Products typically made with extrusion coating and lamination are lidding stock, candy wrapper, snack food bags, medical packaging, condiment packages, soup sachets, toothpaste tubes, frozen food boxes, ready meal trays and cable wrap.

In an extrusion coating process, an extruder converts a solid coating compound into a melt at the appropriate temperature required for coating. The plasticized coating compound is pressed through a sheeting die and transferred directly onto the substrate to be coated.

Typically used coating materials in extrusion coating are thermoplastic polymers such as polyethylene, polypropylene, thermoplastic elastomers and polymer/additive compounds thereof. However, such thermoplastic polymers are associated with certain drawbacks. For example, polyethylene-based extrusion coatings require extrusion temperatures that generate excessive odor, causing emissions of aldehydes, and are not compatible in coextrusion with heat-sensitive polymers. Furthermore, they are often not compostable or biodegradable.

Compostable plastics applied in extrusion paper coating are available in the market, e.g., polylactides (PLA) or blends of PLA and poly(butylene adipate terephthalate) (PBAT), which are commercially available from BASF under the trade name Ecovio®. There have been several descriptions of biodegradable polymer films comprising PLA and PBAT.

CN 107793720A describes a full biodegradable plastic film that is suitable for peanut mulch film and a preparation method thereof. The plastic film consists of the following ingredients: 100 parts of PLA; 70 to 90 parts of PBAT; 0.5 to 1.0 parts of nucleating agent; 5 to 10 parts of composite anti-hydrolysis agent; 0.5 to 1.5 parts of composite anti-ultraviolet agent; 3 to 6 parts of molecular weight regulator; 20 to 30 parts of flexible modifying agent. The flexible modifying agent used therein is a low molecular weight polycaprolactone with an average molecular weight of 1000 to 3000.

EP 1227129A1 describes a mixture of biodegradable polyesters including an aromatic-aliphatic polyester (A) such as PBAT, an aliphatic polyester (B) such as polybutylene sebacate or poly-ε-caprolactone, and a polylactic acid polymer (C). The mixture comprises 40 to 70% by weight, based on the total weight of (A) and (B), of (A) and 6 to 30% by weight, based on the total weight of (A), (B) and (C), of (C).

WO 02/059198 A1 describes a mixture of biodegradable polyesters comprising a polyhydroxy acid of the poly-ε-caprolactone type (A) and its copolymers, an aliphatic polyester (B) such as polybutylene sebacate, and a polymer of polylactic acid (C). The mixture comprises 40 to 70% by weight, based on the total weight of (A) and (B), of (A) and 2 to 30% by weight, based on the total weight of (A), (B) and (C), of (C).

### SUMMARY OF THE INVENTION

Yet, there is still the need to improve the properties of the extrusion coating applying compostable or biodegradable polymers in terms of adhesion to the paper substrate, which is an important criterion to evaluate the quality of an extrusion coating. At the same time, the applied compostable or biodegradable polymers should be suitable for a high coating line speed that is correlated with the coating weight of the applied polymers and defines the practicability and profitability of the extrusion coating process.

The aim of the present invention was accordingly to provide biodegradable polymer blends, which are better suitable for extrusion coating, especially, which exhibit better adhesion to the paper substrate while at the same time being suitable for a high coating line speed.

Surprisingly, it was found that modifying biodegradable polymer blends comprising at least one biodegradable polyester by adding polycaprolactone (PCL) having a specific molecular weight results in improved adhesion at high coating lines speed.

The present invention therefore relates to a biodegradable polymer blend comprising
10 to 80% by weight, based on the total weight of polyester a), polymer b) and polycaprolactone c), of at least one biodegradable polyester a) selected from the group consisting of aliphatic-aromatic polyesters, aliphatic polyesters, which are different from polymers b) and c), and mixtures thereof;
18 to 88% by weight, based on the total weight of polyester a), polymer b) and polycaprolactone c), of at least one polymer b), selected from the group consisting of polyhydroxyalkanoates, polylactides, polyglycolic acid and mixtures thereof;
2 to 72% by weight, based on the total weight of polyester a), polymer b) and polycaprolactone c), of at least one polycaprolactone c) having a viscosity number of at least 110 ml/g, in particular at least 150 ml/g, preferably at least 200 ml/g, especially at least 250 ml/g, as determined according to DIN 53728-3:1985-1;
   wherein the total weight of polyester a), polymer b) and polycaprolactone c) is at least 50% by weight, based on the total weight of the blend.

The present invention is associated with several benefits.
The biodegradable polymer blend according to the invention improves the adhesion of the coating to the substrate while not negatively affecting the processability.
The biodegradable polymer blend according to the invention provides a good flowability.
The biodegradable polymer blend according to the invention has a lower tendency toward edge waving in comparison with known solutions in extrusion coating, so that it is possible to employ higher web speeds in the coating process and to achieve a significant saving of material.
The biodegradable polymer blend according to the invention protects the substrate from oil, fat and moisture and, owing to their weldability with themselves and paper, cardboard and metal, permits the production of, for example, coffee cups, beverage cartons or cartons for frozen food.
Very good biodegradability of the overall system. Industrial and home compostable acc. to DIN EN 13432/NFT 51800 if suitable substrates are used.

Therefore, a second aspect of the present invention relates to mono-layered or multi-layered films comprising or consisting of at least one polymer layer containing or consisting of the biodegradable polymer blend according to the invention. A further aspect of the present invention relates to laminates comprising or consisting of at least one mono-layered or multi-layered film containing or consisting of at least one layer containing or consisting of a biodegradable polymer blend according to the invention, and a substrate onto which the film is laminated.

Yet, further aspects of the present invention relate to
materials, which are selected from packaging; paper and cardboard cups and plates; carrier bags; paper adhesive tape; paper labels; flower pots; and plant pots, where the material comprises at least one film, as defined hereinafter or a laminate, as defined hereinafter;
a method for producing rigid packaging articles which comprises shaping a polymer blend, as defined herein and hereinafter, or a mono- or multilayer sheet or laminate comprising a polymer blend, as defined herein and hereinafter, by thermoforming or injection molding.

Additional aspects of the present invention also relate to use of the biodegradable polymer blend according to the invention for coating a substrate layer or for producing a rigid packaging article and a process for coating a substrate layer, comprising steps: step a) providing a substrate layer, and step B) coating the substrate by one or more polymer layers, where at least one of the layers comprises or consists of the inventive biodegradable polymer blend.

### DETAILED DESCRIPTION OF THE INVENTION

Here and throughout the specification, the terms “compostable” and “biodegradable” are used synonymously.

Here and throughout the specification, the terms “polylactic acid” and “polylactide” are used synonymously.

Here and throughout the specification, the terms “wt.-%” and “% by weight” are used synonymously.

The “molecular weight Mn” or the “molar mass Mn” is the number-average molecular weight or molar mass. The “molecular weight Mw” or the “molar mass Mw” is the mass-average molecular weight or molar mass. If not stated otherwise, the Mn and Mw were determined by GPC with an RI (refractive index) detector, using a mixture of hexafluoroisopropanol and 0.05% potassium trifluoroacetate as an eluent (temperature: 40° C., flow rate: 1 mL/min) and polymethyl methacrylate of defined molecular weight as standards for calibration.

Here and throughout the specification, the melt volume rate (MVR) refers to values determined according to EN ISO 1133 (190° C., 2.16 kg weight), if not stated otherwise.

The MVR of polycaprolactone was determined according to EN ISO 1133 at 160° C., 2.16 kg weight. The sample to be measured is usually dried for 3 hours at 80° C. under 100 mbar. The measurement can be carried out with a MI-ROBO apparatus of Göttfert.

Here and throughout the specification, the acid number (AN) is determined according to the following method: 1.0 g of the polymer are dissolved in a mixture of 10 mL toluene and 10 mL pyridine. After the addition of 5 mL deionized water and 50 mL tetrahydrofuran, the solution is titrated with an ethanolic potassium hydroxide standard solution of known concentration. The blind value is determined at the same procedure but without the polymer.

Here and throughout the specification, hydroxyl number is determined according to DIN EN ISO 4629-2, if not stated otherwise.

Here and throughout the specification, the viscosity number (VN) is determined according to DIN 53728-3:1985-1 at 25° C. using a solution of the respective polymer in a 50:50 w/w mixture of phenol and 1,2-dichlorobenzene.

Here and throughout the specification, the glass transition temperature (Tg) is determined by means of dynamic differential scanning calorimetry (DSC) to DIN EN ISO 11357-1:2017-02, if not stated otherwise.

Here and throughout the specification, the terms “melting temperature (Tm)” and “melting point” are used synonymously. Tm is determined by means of dynamic differential scanning calorimetry (DSC) according to DIN EN ISO 11357-3:2018-07, if not stated otherwise.

In the context of the present invention, the feature “biodegradable” is fulfilled for a substance or a mixture of substances when said substance or the mixture of substances has a percentage degree of biodegradability of at least 90% according to DIN EN 13432.

In general, the biodegradability leads to the polymer blend decomposing in an appropriate and detectable timespan. The degradation may take place enzymatically, hydrolytically, oxidatively and/or by the action of electromagnetic radiation, for example UV radiation, and is generally predominantly effected by the action of microorganisms, such as bacteria, yeasts, fungi and algae. The biodegradability can be quantified, for example, by mixing the polymer blend with compost and storing it for a certain time. For example, according to DIN EN 13432, CO₂-free air is allowed to flow through matured compost during the composting and said compost is subjected to a defined temperature program. Here, the biodegradability is defined via the ratio of the net CO₂ release by the sample (after subtraction of the CO₂ release by the compost without sample) to the maximum CO₂ release by the sample (calculated from the carbon content of the sample) as percentage degree of biodegradability. Biodegradable polymer blends show substantial degradation phenomena, such as fungal growth and formation of cracks and holes, as a rule after only a few days of composting.

Other methods for determining the biodegradability are described, for example, in ASTM D 5338 and ASTM D 6400-4.

Here and throughout the specification, the terms “the total weight of the biodegradable polymer blend”, “the total weight of the polymer blend” and “the total weight of the blend” are used synonymously and refer to the total weight of the polymer blend in anhydrous form, if not stated otherwise.

Here and throughout the specification, the term “the total weight of polyester a), polymer b) and polycaprolactone c)” is to be understood as the sum of the total weight of polyester a), the total weight of polymer b) and the total weight of polycaprolactone c).

### Polyester a)

The biodegradable polymer blend according to the invention comprises 10 to 80% by weight, preferably 15 to 50% by weight, especially 20 to 40% by weight, based on the total weight of polyester a), polymer b) and polycaprolactone c), of at least one biodegradable polyester a) selected from the group consisting of aliphatic-aromatic polyesters, aliphatic polyesters, which are different from polymers b) and c), and mixtures thereof.

The term polyester a) also includes polyesteramides, polyetheresters, polyesterurethanes and polyester carbonates, including aliphatic and semiaromatic polyesteramides, aliphatic and semiaromatic polyetheresters, aliphatic and semiaromatic polyesterurethanes and aliphatic and semiaromatic aliphatic polyester carbonates. Here and throughout the specification, the term polyester a) is different from polymer b) and c), as defined herein.

Polyesters having a melt volume rate (MVR) according to EN ISO 1133 (190° C., 2.16 kg weight) of from 0.5 to 70 cm³/10 min, preferably 1 to 65 cm³/10 min, more preferably 1 to 60 cm³/10 min are particularly suitable as the polyester a).

Preferably, the polymer blend of the present invention comprises at least one polyester a), which has a glass transition temperature Tg or melting temperature Tm in the range from 45 to 160° C., in particular in the range from 50 to 150° C., especially in the range from 60 to 140° C. If the polymer has a melting point, i.e. is semicrystalline or crystalline, it preferably has a melting or crystallization temperature in the range from 45 to 160° C., in particular in the range from 50 to 150° C., especially in the range from 60 to 140° C. If the polymer is amorphous, it preferably has a Tg in the range from 45 to 160° C., in particular in the range from 50 to 150° C., especially in the range from 60 to 140° C.

The polyester a) has usually a number average molecular weight (Mn) in the range from 1000 to 100000 g/mol, in particular in the range from 1000 to 75000 g/mol, preferably in the range of 1500 to 70000 g/mol. The weight-average molecular weight (Mw) of the polyester a) is typically in the range of 3000 to 300000 g/mol, preferably in the range of 3000 to 200000 g/mol. The Mw/Mn ratio is typically in the range of 1 to 6, preferably in the range of 2 to 5. The viscosity number (VN) is from 50 to 450 g/ml, preferably from 80 to 250 g/ml. The melting point is in the range from 85 to 150° C., preferably in the range from 95 to 140° C., as determined from DSC.

According to the invention, the biodegradable polyester a) is selected from the group consisting of aliphatic-aromatic polyesters, aliphatic polyesters, which are different from polymers b) and c), and mixtures thereof.

Here and throughout the specification, aliphatic polyesters are understood to mean polyesters based on aliphatic dicarboxylic acids and aliphatic dihydroxyl compounds, and polyesters based on mixtures of aliphatic dicarboxylic acids with aliphatic dicarboxylic acids and aliphatic dihydroxyl compounds. To prepare the aliphatic-aliphatic polyesters, instead of the dicarboxylic acids, their respective ester-forming derivatives or mixtures thereof with the dicarboxylic acids may also be used.

Aliphatic dicarboxylic acids and the ester-forming derivatives thereof that are generally considered are those having 2 to 18 carbon atoms, preferably 4 to 10 carbon atoms. They may be either linear or branched. However, it is also possible in principle to employ dicarboxylic acids having a greater number of carbon atoms, for example having up to 50 carbon atoms.

Examples of aliphatic dicarboxylic acids and the ester-forming derivatives include, but are not limited to: oxalic acid, malonic acid, succinic acid, 2-methylsuccinic acid, glutaric acid, 2-methylglutaric acid, 3-methylglutaric acid, α-ketoglutaric acid, adipic acid, pimelic acid, azelaic acid, sebacic acid, 1,12-dodecanedioic acid, brassylic acid, fumaric acid, 2,2-dimethylglutaric acid, suberic acid, diglycolic acid, oxaloacetic acid, glutamic acid, aspartic acid, itaconic acid and maleic acid, their anhydrides and their C₁-C₄-alkyl esters. These dicarboxylic acids or the ester-forming derivatives thereof may be used individually or as a mixture of two or more thereof.

It is preferable to employ succinic acid, adipic acid, azelaic acid, sebacic acid, 1,12-dodecanedioic acid, brassylic acid or their respective ester-forming derivatives or mixtures thereof. It is particularly preferable to employ succinic acid, adipic acid or sebacic acid or the respective ester-forming derivatives thereof or mixtures thereof. Succinic acid, azelaic acid, sebacic acid and brassylic acid additionally have the advantage that they are obtainable from renewable raw materials.

Preferred examples of suitable aliphatic polyesters are, but not limited to aliphatic polyesters in which the aliphatic dicarboxylic acid is selected from succinic acid, adipic acid, azelaic acid, sebacic acid, 1,12-dodecanedioic acid, brassylic acid and mixtures thereof. Particular preference is given to succinic acid, adipic acid and sebacic acid and mixtures thereof.

Examples of aliphatic diols which are suitable for the preparation of the aliphatic polyesters are, for example, branched or linear alkanediols having 2 to 12 carbon atoms, preferably 4 to 6 carbon atoms, or cycloalkanediols having 5 to 10 carbon atoms. Examples of suitable alkanediols are ethylene glycol, 1,2-propanediol, 1,3-propanediol, 1,2-butanediol, 1,4-butanediol, 1,5-pentanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 2,2,4-trimethyl-1,6-hexanediol, especially ethylene glycol, 1,3-propanediol, 1,4-butanediol and 2,2-dimethyl-1,3-propanediol (neopentyl glycol). Examples of cycloalkanediols are cyclopentanediol, 1,4-cyclohexanediol, 1,2-cyclohexanedimethanol, 1,3-cyclohexanedimethanol, 1,4-cyclohexanedimethanol and 2,2,4,4-tetramethyl-1,3-cyclobutanediol. The aliphatic polyesters may also comprise mixtures of different alkanediols condensed. In particular, preference is given to 1,4-butanediol and propane-1,3-diole, more particularly to 1,4-butanediol, especially in combination with one or two aliphatic dicarboxylic acids selected from succinic acid, adipic acid and sebacic acid. Propane-1,3-diol has an advantage that it is obtainable as a renewable raw material. 1,4-Butanediol is also obtainable from renewable raw materials. PCT/EP2008/006714 discloses a biotechnological process for the preparation of 1,4-butanediol starting from different carbohydrates using microorganisms from the class consisting of the Pasteurellaceae.

Examples of preferred aliphatic polyesters are poly(butylene succinate-co-adipate), poly(butylene succinate), poly(butylene sebacate), poly(butylene succinate-co-sebacate) and mixtures thereof. Even more preferred examples of aliphatic polyesters are poly(butylene succinate-co-adipate), poly(butylene succinate), poly(butylene succinate-co-sebacate) and mixtures thereof. Suitable aliphatic polyesters of this type are commercially available und the following product brands BioPBS™ by PTT-MCC.

The preferred aliphatic polyesters of the component a) frequently have a number average molecular weight Mn in the range from 1000 to 100000 g/mol, particularly in the range from 1000 to 75000 g/mol, especially in the range from 1500 to 65000 g/mol, as determined from GPC.

The preferred aliphatic polyesters of the component a) frequently have a melting point in the range of 50 to 130° C., particularly in the range of 55 to 125° C., especially in the range of 65 to 120° C., as determined by DSC.

In particular, the aliphatic polyesters of component a) include aliphatic copolyesters, that are partially or highly crystalline and solid.

Aliphatic polyesters of component a), in particular aliphatic copolyesters preferably have a melt volume rate (MVR) according to EN ISO 1133 (190° C., 2.16 kg weight) in the range of 2.5 to 30 cm³/10 min.

In preferred polymer blends of the invention, the component a) comprises an aliphatic-aromatic polyester.

Aliphatic-aromatic polyesters are also referred to as semi-aromatic polyesters, i.e. polyesters based on aromatic dicarboxylic acids and aliphatic dihydroxyl compounds, and polyesters based on mixtures of aromatic dicarboxylic acids with aliphatic dicarboxylic acids and aliphatic dihydroxyl compounds. Aliphatic-aromatic polyesters are preferably polyesters based on mixtures of aliphatic dicarboxylic acids with aromatic dicarboxylic acids and aliphatic dihydroxyl compound. These polymers may be present individually or in the mixtures thereof.

Preferably, “aliphatic-aromatic polyesters” shall also be understood to mean polyester derivatives such as polyetheresters, polyesteramides or polyetheresteramides and polyesterurethanes, as described, for example, in WO 2012/2013506. The suitable aliphatic-aromatic polyesters include linear, non-chain-extended polyesters, as described for example in WO 92/09654. Preference is given to chain-extended and/or branched aliphatic-aromatic polyesters. The latter are known from WO 96/15173, WO 96/15174, WO 96/15175, WO 96/15176, WO 96/21689, WO 96/21690, WO 96/21691, WO 96/21692, WO 96/25446, WO 96/25448 and WO 98/12242, to which explicit reference is made. Likewise considered are mixtures of different aliphatic-aromatic polyesters. Interesting recent developments are based on renewable raw materials and are described inter alia in WO 2006/097353, WO 2006/097354 and WO 2010/034710.

The preferred aliphatic-aromatic polyesters are characterized by a number average molecular weight Mn in the range from 1000 to 100000 g/mol, especially in the range from 1000 to 75000 g/mol, preferably in the range from 1500 to 50000 g/mol, as determined by GPC.

Preferred aliphatic-aromatic polyesters include polyesters comprising as essential components:
an acid component formed from
i. 20 to 95 mol %, in particular 20 to 90 mol %, especially 20 to 85 mol %, based on the total mol percentage of the components i and ii, of at least one aliphatic dicarboxylic acid or the ester-forming derivatives thereof or mixtures thereof as component i;
ii. 5 to 80 mol %, in particular 10 to 80 mol %, especially 15 to 80 mol %, based on the total mol percentage of the components i and ii, of at least one aromatic dicarboxylic acid or the ester-forming derivative thereof or mixtures thereof as component ii;
at least one diol as component iii selected from C₂-C₁₂-alkanediols;
optionally a component iv selected from one or more chain extender as component iv.a and/or one or more crosslinking agent as component iv.b.

Aliphatic dicarboxylic acids and the ester-forming derivatives thereof (component i) are as defined above in the context of aliphatic polyesters. Examples thereof are also, as shown above. The aliphatic dicarboxylic acids or the ester-forming derivatives thereof can be used individually or as a mixture.

Preferred aliphatic dicarboxylic acids include, but are not limited to, succinic acid, adipic acid, sebacic acid, azelaic acid, 1,12-dodecanedioic acid, brassylic acid or their respective ester-forming derivatives or mixtures thereof. It is particularly preferable to employ adipic acid, sebacic acid or azelaic acid or the respective ester-forming derivatives thereof or mixtures thereof. As mentioned above, succinic acid, sebacic acid, azelaic acid, and brassylic acid additionally have the advantage that they are obtainable from renewable raw materials.

The aliphatic dicarboxylic acid (component i) is present in particular in an amount from 20 to 90 mol %, especially from 20 to 85 mol % or from 25 to 85 mol % or from 30 to 85 mol %, based on the total mol percentage of the acid components i and ii. Sebacic acid, azelaic acid and brassylic acid are obtainable from renewable raw materials, in particular from castor oil.

The aromatic dicarboxylic acids or the ester-forming derivatives thereof (ii) may be used individually or as a mixture of two or more thereof. Particular preference is given to using terephthalic acid or furan-2,5-dicarboxylic acid and the ester-forming derivatives thereof. The di-C₁-C₆-alkyl esters, such as dimethyl, diethyl, di-n-propyl, diisopropyl, di-n-butyl, diisobutyl, di-tert-butyl, di-n-pentyl-, di-isopentyl or di-n-hexyl esters may be mentioned in particular as ester-forming derivatives. Anhydrides of the dicarboxylic acids can also be used. A particularly suitable ester-forming derivative of terephthalic acid is dimethyl terephthalate.

In one group of embodiments, the aromatic dicarboxylic acid is terephthalic acid or an ester forming derivative thereof. Preferably, the terephthalic acid (component ii) or the ester forming derivative thereof, respectively, is present in an amount from 30 to 75 mol %, more preferably from 35 to 65 mol % and especially from 40 to 60 mol %, based on the total mol percent of the acid components i and ii. In this case, the total amount of aliphatic dicarboxylic acid or the ester-forming derivative thereof is preferably in the range of 25 to 70 mol %, more preferably in the range of 35 to 65 mol % and especially in the range of 40 to 60 mol %, based on the total mol percent of the acid components i and ii.

In another group of embodiments, the aromatic dicarboxylic acid is furan-2,5-dicarboxylic acid or an ester forming derivative thereof. Preferably, the furan-2,5-dicarboxylic acid (component ii) or the ester forming derivative thereof, respectively, is present in an amount from 40 to 80 mol %, more preferably from 50 to 80 mol % and especially from 60 to 80 mol %, based on the total mol percent of the acid components i and ii. In this case, the total amount of aliphatic dicarboxylic acid or the ester-forming derivative thereof is preferably in the range of 20 to 60 mol %, more preferably in the range of 20 to 50 mol % and especially in the range of 20 to 40 mol %, based on the total mol percent of the acid components i and ii.

Generally, the diols (component iii) are selected from branched or linear alkanediols having 2 to 12 carbon atoms, preferably 4 to 6 carbon atoms, or cycloalkanediols having 5 to 10 carbon atoms. Examples of suitable alkanediols are ethylene glycol, propane-1,2-diol, propane-1,3-diol, butane-1,2-diol, butane-1,4-diol, pentane-1,5-diol, 2,4-dimethyl-2-ethylhexane-1,3-diol, 2,2-dimethylpropane-1,3-diol, 2-ethyl-2-butylpropane-1,3-diol, 2-ethyl-2-isobutylpropane-1,3-diol, 2,2,4-trimethylhexane-1,6-diol, especially ethylene glycol, propane-1,3-diol, butane-1,4-diol and 2,2-dimethylpropane-1,3-diol (neopentyl glycol). Examples of suitable cylcoalkanediols are cyclopentanediol, cyclohexane-1,4-diol, cyclohexane-1,2-dimethanol, cyclohexane-1,3-dimethanol, cyclohexane-1,4-dimethanol and 2,2,4,4-tetramethylcyclobutane-1,3-diol. The aliphatic-aromatic polyesters may also include combinations of different alkanediols or cycloalkanediols. Particular preference is given to butane-1,4-diol and propane-1,3-diol, especially to butane-1,4-diol. Propane-1,3-diol has an advantage that it is obtainable as a renewable raw material. 1,4-Butanediol is also obtainable from renewable raw materials. PCT/EP2008/006714 discloses a biotechnological process for the preparation of 1,4-butanediol starting from different carbohydrates using microorganisms from the class consisting of the Pasteurellaceae.

As a rule, the diol (component iii) is adjusted with respect to the acids (components i and ii) in a ratio of diol to dioic acids of from 1.0 to 2.5:1 and preferably from 1.3 to 2.2:1 at the beginning of the polymerization. Excess amounts of diol are removed during the polymerization so that an approximately equimolar ratio is established at the end of the polymerization. Approximately equimolar is understood as meaning a diol/dioic acid ratio of from 0.98 to 1.02:1.

In particular, suitable aliphatic-aromatic polyesters comprise:
i. from 20 to 95 mol %, in particular 20 to 90 mol %, especially 20 to 85 mol %, based on the total mol percentage of the components i to ii, of one or more aliphatic dicarboxylic acid ester-forming derivatives or aliphatic dicarboxylic acids selected from the group consisting of succinic acid, adipic acid, sebacic acid, azelaic acid, brassylic acid and mixtures thereof;
ii. from 5 to 80 mol %, in particular 10 to 80 mol %, especially 15 to 80 mol %, based on the total mol percentage of the components i to ii, of one or more aromatic dicarboxylic acid ester-forming derivatives or aromatic dicarboxylic acids selected from the group consisting of a terephthalic acid and furan-2,5-dicarboxylic acid, and mixtures thereof;
iii. from 98 to 102 mol %, based on the components i to ii, of a C₂-C₃-alkylenediol or C₂-C₆-oxyalkylenediol; and
iv. from 0.00 to 2% by weight, particularly from 0.01 to 2% by weight, especially from 0.2 to 1.5% by weight and particularly especially from 0.35 to 1% by weight, based on the total weight of components i to iii, of a chain extender (component iv.a) and/or crosslinking agent (component iv.b) selected from the group consisting of di- or polyfunctional isocyanates, isocyanurates, oxazolines, epoxides, carboxylic anhydrides, alcohols having at least three functional groups and carboxylic acids having at least three functional groups.

For paper coating, in particular aliphatic-aromatic polyesters having a high proportion of aliphatic dicarboxylic acid of from 20 to 95 mol %, in particular 20 to 90 mol %, especially 20 to 85 mol %, based on the total mol percentage of the aliphatic dicarboxylic acid and aromatic dicarboxylic acid, are suitable. With a higher proportion of the aliphatic dicarboxylic acid in the aliphatic-aromatic polyesters, it is possible to realize thinner layers. Films of these polyesters show less tendency to melt resonance in coating plants.

In preferred groups of embodiments, the aliphatic-aromatic polyester is selected from poly(butylene adipate-co-terephthalate), poly(butylene sebacate-co-terephthalate), poly(butylene azelate-co-terephthalate), poly(butylene succinate-co-terephthalate), poly(butylene adipate-co-sebacate-co-terephthalate), poly(butylene adipate-co-azelate-co-terephthalate), poly(butylene adipate-co-succinate-co-terephthalate), poly(butylene sebacate-co-azelate-co-terephthalate), poly(butylene sebacate-co-succinate-co-terephthalate), poly(butylene azelate-co-succinate-co-terephthalate), poly(butylene adipate-co-furanoate), poly(butylene sebacate-co-furanoate), poly(butylene azelate-co-furanoate), poly(butylene succinate-co-furanoate), poly(butylene adipate-co-sebacate-co-furanoate), poly(butylene adipate-co-azelate-co-furanoate), poly(butylene adipate-co-succinate-co-furanoate), poly(butylene sebacate-co-azelate-co-furanoate), poly(butylene sebacate-co-succinate-co-furanoate), poly(butylene azelate-co-succinate-co-furanoate) and mixtures thereof. The aforementioned aliphatic-aromatic polyesters have VST/A50 (vicat softening temperature) values in the range of 50 to 160° C., in particular in the range of 55 to 150° C., as determined according to DIN EN ISO 306.

In more preferred groups of embodiments, the aliphatic-aromatic polyester is selected from poly(butylene adipate-co-terephthalate) (PBAT), poly(butylene sebacate-co-terephthalate) (PBSeT), poly(butylene azelate-co-terephthalate) (PBAzT), poly(butylene succinate terephthalate (PBST), poly(butylene adipate-co-sebacate-co-terephthalate) (PBASeT), poly(butylene adipate-co-azelate-co-terephthalate) (PBAAzT), poly(butylene adipate-co-furanoate) (PBAF), poly(butylene sebacate-co-furanoate) (PBSeF), poly(butylene azelate-co-furanoate) (PBAzF), poly(butylene succinate-co-furanoate) (PBSF), poly(butylene adipate-co-sebacate-co-furanoate) (PBASeF), poly(butylene adipate-co-azelate-co-furanoate) (PBAAzF) and mixtures thereof.

In a preferred groups of embodiments, polyester a) is selected from the group consisting of poly(butylene adipate-co-terephthalate), poly(butylene sebacate-co-terephthalate), poly(butylene azelate-co-terephthalate), poly(butylene succinate-co-terephthalate), poly(butylene adipate-co-sebacate-co-terephthalate), poly(butylene adipate-co-azelate-co-terephthalate), poly(butylene adipate-co-succinate-co-terephthalate), poly(butylene sebacate-co-azelate-co-terephthalate), poly(butylene sebacate-co-succinate-co-terephthalate), poly(butylene azelate-co-succinate-co-terephthalate), poly(butylene adipate-co-furanoate), poly(butylene sebacate-co-furanoate), poly(butylene azelate-co-furanoate), poly(butylene succinate-co-furanoate), poly(butylene adipate-co-sebacate-co-furanoate), poly(butylene adipate-co-azelate-co-furanoate), poly(butylene adipate-co-succinate-co-furanoate), poly(butylene sebacate-co-azelate-co-furanoate), poly(butylene sebacate-co-succinate-co-furanoate), poly(butylene azelate-co-succinate-co-furanoate), poly(butylene succinate), poly(butylene succinate-co-adipate), poly(butylene succinat-co-sebacate) and mixtures thereof.

In a particularly preferred groups of embodiments, polyester a) is selected from the group consisting of poly(butylene adipate-co-terephthalate), poly(butylene sebacate-co-terephthalate), poly(butylene azelate-co-terephthalate), poly(butylene adipate-co-sebacate-co-terephthalate), poly(butylene adipate-co-azelate-co-terephthalate), poly(butylene adipate-co-furanoate), poly(butylene sebacate-co-furanoate), poly(butylene azelate-co-furanoate), poly(butylene succinate-co-furanoate), poly(butylene adipate-co-sebacate-co-furanoate), poly(butylene adipate-co-azelate-co-furanoate), poly(butylene succinate), poly(butylene succinate-co-adipate), poly(butylene succinate-co-sebacate) and mixtures thereof.

The amount of the aliphatic-aromatic polyester is in particular at least 50% by weight, especially at least 70% by weight, or at least 80% by weight, or at least 90% by weight, and may be as high as 100% by weight, based on the total weight of component a).

The synthesis of the polyester a) described is effected by the process described in WO-A 92/09654, WO-A 96/15173 or preferably in PCT/EP2009/054114 and PCT/EP2009/054116, preferably in a two-stage reaction cascade.

By means of the two above-mentioned processes, it is possible to tailor the desired MVR range simply by the choice of the process parameters, such as residence time, reaction temperature and amount taken off at the top of the tower reactor.

Adaptations of the MVR to lower values can be achieved by addition of components iv) in the stated concentration range or, in the case of the polymer mixtures, by a suitable compatibilizer.

Optionally, the polyester may comprise from 0 to 2% by weight, in particular from 0.2 to 1.5% by weight and especially from 0.35 to 1% by weight, based on the total weight of the components i to iii, of a chain extender (iv.a) and/or a crosslinking agent (iv.b) selected from the group consisting of di- or polyfunctional isocyanates, isocyanurates, oxazolines, carboxylic anhydrides, such as maleic anhydride, epoxides, in particular an epoxide-containing poly(meth)acrylate, alcohols having at least three functional groups and carboxylic acids having at least three functional groups are used. Suitable chain extenders (iv.a) are in particular difunctional isocyanates, isocyanurates, oxazolines, carboxylic anhydride or epoxides.

Chain extenders and alcohols or carboxylic acid derivatives having at least three functional groups may also be considered as crosslinking agents. Particularly preferred compounds have from three to six functional groups. The following may be mentioned by way of example: tartaric acid, citric acid, malic acid; trimethylolpropane, trimethylolethane, pentaerythritol; polyethertriols and glycerol, trimesic acid, trimellitic acid, trimellitic anhydride, pyromellitic acid and pyromellitic anhydride. Polyols such as trimethylolpropane, pentaerythritol and in particular glycerol are preferred.

Examples of chain extenders are described in more detail below.

Epoxides are in particular selected from homopolymers and copolymers containing epoxide groups. The units carrying epoxide groups are preferably formed from glycidyl esters or glycidyl ethers having an ethylenically unsaturated double bond, in particular from (meth)acrylates. Suitable comonomers are styrene, acrylates and/or methacrylates. Copolymers having a proportion of glycidyl (meth)acrylate of greater than 20% by weight, particularly preferably of greater than 30% by weight, especially preferably of greater than 50% by weight, based on the total amount of monomers forming the epoxide polymer have proven advantageous. The epoxide equivalent weight (EEW) in these polymers is preferably from 150 to 3000 g/equivalent, particularly preferably from 200 to 500 g/equivalent. The average molecular weight (weight average) Mw of the polymers is preferably from 2000 to 25000 g/mol, in particular from 3000 to 8000 g/mol. The average molecular weight (number average) Mn of the polymers is preferably from 400 to 6000 g/mol, in particular from 1000 to 4000 g/mol. The polydispersity (Mw/Mn) is in general from 1.5 to 5. Copolymers of the abovementioned type which contain epoxide groups are sold, for example, by BASF under the brand Joncryl® ADR. A particularly suitable chain extender is Joncryl® ADR 4468 or Joncryl® ADR 4400.

As a rule, it is expedient to add the crosslinking compounds having at least three functional groups at a relatively early time to the polymerization of the polyester a).

Suitable bifunctional chain extenders are the following compounds:

An aromatic diisocyanate (component iv.a) is understood as meaning in particular toluene 2,4-diisocyanate, toluene 2,6-diisocyanate, 2,2′-diphenylmethane diisocyanate, 2,4′-diphenylmethane diisocyanate, 4,4′-diphenylmethane diisocyanate, naphthylene 1,5-diisocyanate or xylylene diisocyanate. Among these, 2,2′-, 2,4′- and 4,4′-diphenylmethane diisocyanate are particularly preferred. In general, the latter diisocyanates are used as a mixture. The diisocyanates may also comprise urethione groups in minor amounts, for example up to 5% by weight, based on the total weight of the diisocyanate, for example for blocking the isocyanate groups.

In the context of the present invention, an aliphatic diisocyanate is understood as meaning in particular linear or branched alkylene diisocyanates or cycloalkylene diisocyanates having 2 to 20 carbon atoms, preferably 3 to 12 carbon atoms, e.g. hexamethylene 1,6-diisocyanate, isophorone diisocyanate or methylenebis(4-iso-cyanatocyclohexane). Particularly preferred aliphatic diisocyanates are isophorone diisocyanate and in particular hexamethylene 1,6-diisocyanate.

The preferred isocyanurates include the aliphatic isocyanurates which are derived from alkylene diisocyanates or cycloalkylene diisocyanates having 2 to 20 carbon atoms, preferably 3 to 12 carbon atoms, e.g. isophorone diisocyanate or methylenebis(4-iso-cyanatocyclohexane). The alkylene diisocyanates may be either linear or branched. Isocyanurates which are based on n-hexamethylene diisocyanate, for example cyclic trimers, pentamers or higher oligomers of hexamethylene 1,6-diisocyanate, are particularly preferred.

### Polymer b)

The biodegradable polymer blend according to the invention comprises 18 to 88% by weight, particularly 35 to 70% by weight, especially 40 to 70% by weight, based on the total weight polyester a), polymer b) and polycaprolactone c), of at least one polymer b), selected from the group consisting of polyhydroxyalkanoates, polylactides, polyglycolic acid and mixtures thereof.

Polyhydroxyalkanoates are also referred to as polyhydroxy fatty acids and are understood in the context of the invention as meaning those which comprise monomers having a chain length in the polymer backbone of at least 3 carbon atoms. Polylactic acid and polyhydroxyacetic acid (also referred to as polyglycolic acid) are therefore not polyhydroxyalkanoates in the context of the invention. In the context of the invention, polycaprolactones (PCL) are not understood as polyhydroxyalkanoates, either.

In accordance with the invention, preference is given to using at least one polyhydroxyalkanoate comprising repeating monomer units of the formula (1)

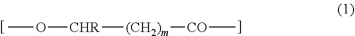

where R is hydrogen or a linear or branched alkyl group having 1 to 20, preferably 1 to 16 carbon atoms, preferably 1 to 6 carbon atoms and m=numbers from 1 to 18, preferably 1, 2, 3, 4, 5 and 6; and/or homopolymers of 2-hydroxybutyric acid.

The polyhydroxy fatty acids comprise homopolymers, i.e. polyhydroxy fatty acids consisting of identical hydroxy fatty acid monomers and also copolymers, i.e. polyhydroxy fatty acids consisting of different hydroxy fatty acid monomers.

The polyhydroxy fatty acids may be used individually or in the form of any mixtures.

Polyhydroxy fatty acids in the context of this invention frequently have molecular weights Mw of 5000 to 1000000 g/mol, in particular 30000 to 1000000 g/mol, particularly 70000 to 1000000 g/mol, preferably 100000 to 1000000 g/mol or 200000 to 600000 g/mol and/or melting points in the range of 100 to 190° C.

Polyhydroxy fatty acids preferably have a melt volume rate (MVR) according to EN ISO 1133 (165° C., 5 kg weight) in the range of 1 to 50 cm³/10 min, preferably 1.5 to 40 cm³/10 min, more preferably 2 to 30 cm³/10 min.

In one embodiment of the invention, the at least one polyhydroxyalkanoate is selected from the group consisting of
poly(3-hydroxypropionates) (P3HP);
polyhydroxybutyrates (PHB);
polyhydroxyvalerates (PHV);
polyhydroxyhexanoates (PHHx);
polyhydroxyoctanoates (PHO);
polyhydroxyoctadecanoates (PHOd);
copolyesters of hydroxybutyric acid with at least one monomer selected from the group consisting of 3-hydroxypropionic acid, hydroxyvaleric acids, hydroxyhexanoic acids, hydroxyoctanoic acids and hydroxyoctadecanoic acids;
copolyesters of hydroxyvaleric acid with at least one monomer selected from the group consisting of 3-hydroxypropionic acid, hydroxyhexanoic acids, hydroxyoctanoic acids and hydroxyoctadecanoic acids; and
copolyesters of hydroxyhexanoic acid with at least one monomer selected from the group consisting of 3-hydroxypropionic acid, hydroxyoctanoic acid and hydroxyoctadecanoic acid.

Suitable polyhydroxybutyrates (PHB) may be selected from the group consisting of poly(3-hydroxybutyrates) (P3HB), poly(4-hydroxybutyrates) (P4HB) and copolymers of at least 3 hydroxybutyric acids selected from the group consisting of 3-hydroxybutyric acid and 4-hydroxybutyric acid. Further suitable are copolymers of 3-hydroxybutyric acid and 4-hydroxybutyric acid. These copolymers are characterized by the following abbreviations: [P(3HB-co-4HB)], where 3HB is 3-hydroxybutyrate and 4HB is 4-hydroxybutyrates.

Poly(3-hydroxybutyrates) are marketed for example by Tianan under the brand name Enmat®. Poly-3-hydroxybutyrate-co-4-hydroxybutyrates have been developed by Metabolix in particular. They are nowadays commercialized by CJ CheilJedang.

Suitable polyhydroxyvalerates (PHV) may be selected from the group consisting of
homopolymers of 3-hydroxyvaleric acid [=poly(3-hydroxyvalerates) (P3HV)];
homopolymers of 4-hydroxyvaleric acid [=poly(4-hydroxyvalerates) (P4HV)];
homopolymers of 5-hydroxyvaleric acid [=poly(5-hydroxyvalerates) (P5HV)];
homopolymers of 3-hydroxymethylvaleric acid [=poly(3-hydroxymethylvalerates) (P3MHV)]; and
copolymers of at least 3 hydroxyvaleric acids selected from the group consisting of 3-hydroxyvaleric acid, 4-hydroxyvaleric acid, 5-hydroxyvaleric acid and 3-hydroxymethylvaleric acid.

Suitable polyhydroxyhexanoates (PHHx) may be selected from the group consisting of poly(3-hydroxyhexanoates) (P3HHx), poly(4-hydroxyhexanoates) (P4HHx), poly(6-hydroxyhexanoates) (P6HHx) and copolymers of at least 3-hydroxyhexanoic acids selected from the group consisting of 3-hydroxyhexanoic acid, 4-hydroxyhexanoic acid and 6-hydroxyhexanoic acid.

Suitable polyhydroxyoctanoates (PHO) may be selected from the group consisting of poly(3-hydroxyoctanoates) (P3HO), poly(4-hydroxyoctanoates) (P4HO), poly(6-hydroxyoctanoates) (P6HO) and copolymers of at least 3-hydroxyoctanoic acids selected from the group consisting of 3-hydroxyoctanoic acid, 4-hydroxyoctanoic acid and 6-hydroxyoctanoic acid.

Suitable copolyesters of hydroxybutyric acid with at least one monomer selected from the group consisting of 3-hydroxypropionic acid, hydroxyvaleric acids, hydroxyhexanoic acids, hydroxyoctanoic acids and hydroxyoctadecanoic acids may be selected from the group consisting of
copolyesters of 4-hydroxybutyric acid with 3-hydroxyvaleric acid [P(4HB-co-3HV)];
copolyesters of 3-hydroxybutyric acid with 3-hydroxyvaleric acid [P(3HB-co-3HV)];
copolyesters of 4-hydroxybutyric acid with 3-hydroxyhexanoic acid [P(4HB-co-3HHx)];
copolyesters of 3-hydroxybutyric acid with 3-hydroxyhexanoic acid [P(3HB-co-3HHx)];
copolyesters of 4-hydroxybutyric acid with 3-hydroxyoctanoic acid [P(4HB-co-3HO)];
copolyesters of 3-hydroxybutyric acid with 3-hydroxyoctanoic acid [P(3HB-co-3HO)]; and
copolyesters of 4-hydroxybutyric acid with 3-hydroxyoctadecanoic acid [P(4HB-co-3HOd)] and copolyesters of 3-hydroxybutyric acid with 3-hydroxyoctadecanoic acid [P(3HB-co-3HOd)].

Preference is given to using poly-3-hydroxybutyrate-co-3-hydroxyhexanoate having a 3-hydroxyhexanoate proportion of 1 to 20 and preferably of 3 to 15 mol % based on the total amount of polyhydroxy fatty acid. Such poly-3-hydroxybutyrate-co-3-hydroxyhexanoates [P(3HB-co-3HHx] are known from Kaneka and are commercially available under the trade names Aonilex™ X131A and Aonilex™ X151A.

Suitable copolyesters of hydroxyvaleric acid are preferably copolyesters of 4-hydroxyvaleric acid and/or 3-hydroxyvaleric acid with at least one monomer selected from the group consisting of 3-hydroxypropionic acid, hydroxyhexanoic acids, hydroxyoctanoic acids, especially 3-hydroxyoctanoic acid and hydroxyoctadecanoic acids.

Suitable copolyesters of hydroxyhexanoic acid are preferably copolyesters of 3-hydroxyhexanoic acid with at least one monomer selected from the group consisting of 3-hydroxypropionic acid and hydroxyoctanoic acid, preferably 3-hydroxyoctanoic acid and hydroxyoctadecanoic acids.

In one embodiment of the invention, the at least one polyhydroxyalkanoate is selected from the group consisting of poly(3-hydroxypropionates) (P3HP); copolymers of at least 3 hydroxybutyric acids selected from the group consisting of 3-hydroxybutyric acid and 4-hydroxybutyric acid; copolymers of 3-hydroxybutyric acid and 4-hydroxybutyric acid; poly(3-hydroxyvalerates) (P3HV); poly(4-hydroxyvalerates) (P4HV); poly(5-hydroxyvalerates) (P5HV); poly(3-hydroxymethylvalerates) (P3MHV); copolymers of at least 3 hydroxyvaleric acids selected from the group consisting of 3-hydroxyvaleric acid, 4-hydroxyvaleric acid, 5-hydroxyvaleric acid and 3-hydroxymethylvaleric acid; poly(3-hydroxyhexanoates) (P3HHx); poly(4-hydroxyhexanoates) (P4HHx); poly(6-hydroxyhexanoates) (P6HHx); copolymers of at least 3 hydroxyhexanoic acids selected from the group consisting of 3-hydroxyhexanoic acid, 4-hydroxyhexanoic acid and 6-hydroxyhexanoic acid; poly(3-hydroxyoctanoates) (P3HO); poly(4-hydroxyoctanoates) (P4HO); poly(6-hydroxyoctanoates) (P6HO); copolymers of at least 3 hydroxyoctanoic acids selected from the group consisting of 3-hydroxyoctanoic acid, 4-hydroxyoctanoic acid and 6-hydroxyoctanoic acid; poly(3-hydroxyoctanoates) (P3HO); poly(4-hydroxyoctanoates) (P4HO); poly(6-hydroxyoctanoates) (P6HO); copolymers of at least 3 hydroxyoctanoic acids selected from the group consisting of 3-hydroxyoctanoic acid, 4-hydroxyoctanoic acid and 6-hydroxyoctanoic acid; copolyesters of 3-hydroxybutyric acid with at least one monomer selected from the group consisting of 3-hydroxypropionic acid, hydroxyvaleric acids, hydroxyhexanoic acids, hydroxyoctanoic acids and hydroxyoctadecanoic acids; copolyesters of 4-hydroxybutyric acid with 3-hydroxyoctanoic acid [P(4HB-co-3HO)], copolyesters of 3-hydroxybutyric acid with 3-hydroxyoctanoic acid [P(3HB-co-3HO)], copolyesters of 4-hydroxybutyric acid with 3-hydroxyoctadecanoic acid [P(4HB-co-3HOd)], copolyesters of 3-hydroxybutyric acid with 3-hydroxyoctadecanoic acid [P(3HB-co-3HOd)]; copolyesters of hydroxyvaleric acid, especially of 3-hydroxyvaleric acid or 4-hydroxyvaleric acid with at least one monomer selected from the group consisting of 3-hydroxypropionic acid, hydroxyhexanoic acids, hydroxyoctanoic acids and hydroxyoctadecanoic acids; copolyesters of 3-hydroxyhexanoic acid with at least one monomer selected from the group consisting of 3-hydroxypropionic acid, hydroxyoctanoic acid, preferably 3-hydroxyoctanoic acid and hydroxyoctadecanoic acids.

The suitable polyhydroxyalkanoates have, as a rule, a molecular weight Mw of from 100000 to 1000000 g/mol and preferably from 300000 to 600000 g/mol, as determined from GPC in HFIP as solvent against narrowly distributed PMMA standards.

Polylactide, also known as polylactic acid, is a thermoplastic polyester with backbone formula (C₃H4O₂)ₙ or [—C(CH₃)HC(═O)O—]ₙ, formally obtained by condensation of lactic acid C(CH₃)(OH)HCOOH with loss of water. It can also be prepared by ring-opening polymerization of lactide [—C(CH₃)HC(═O)O—]₂, the cyclic dimer of the basic repeating unit. The suitable PLA typically comprises at least 90% by weight, preferably at least or more than 95% by weight, of the lactic acid repeating unit, based on the total weight of the PLA.

The polylactide may be crystalline, semi-crystalline or amorphous. Particularly, suitable polylactide has a melting or softening point below 240° C., particularly below 230° C., especially below 220° C., as determined by DSC. Generally, the melting point of crystalline or semi crystalline polylactide will be at least 120° C.

Polylactides preferably have a melt volume rate (MFR) according to EN ISO 1133 (190° C., 2.16 kg weight) in the range of 5 to 60 g/10 min, preferably 10 to 55 g/10 min, more preferably 15 to 50 g/10 min.

Preferred polylactides are commercially available from NatureWorks, for example, under the trade name Ingeo™ 6201D, Ingeo™ 6202D, Ingeo™ 6251D, Ingeo™ 3051D, Ingeo™ 4043D, in particular Ingeo™ 3251D; from Total Corbion under the trade name Luminy LX975, LX930, LX175; LX575, L130, LX530, in particular Luminy L105; from Hisun under the trade name Revode 110, 190, in particular Revode 290.

In preferred groups of embodiments, polymer b) is selected from the group consisting of polylactides.

The biodegradable polymer blends comprising at least one an aliphatic-aromatic polyester, as defined above, and polylactic acid are suitable for coating paper. The polymer blends typically have a multiphase structure, i. e. the different polymer components of the blend are present in different spatial domains within the blend. For example, the blend may have a continuous phase and a discontinuous phase distributed in the continuous phase. For example, the polymer b), preferably the polylactic acid, may form the continuous phase of the polymer blend, while the other components form a dispersed phase or a co-continuous phases together with the polylactic acid continuous phase. This may be the case in polymer blends which comprise more than 50% by weight of polylactic acid. In comparison to pure PLA, these blends are notable for reduced neck-in of the melt web on exit from the flat die—the neck-in is reduced by at least 10%, preferably 20 to 80%, more preferably by 30 to 60%. As compared with pure polybutylene adipate terephthalate, PBAT, the melt web is significantly more stable and has better drawing properties to <30 g/m², preferably <20 g/m², more preferably <17 g/m². The effective adhesion to the cellulosic substrate (paper, cardboard) is retained, in dependence on the cooling conditions, by virtue of high web speeds >100 m/min.

The polymer blends may also have a co-continuous phase arrangement, i. e. the different polymer components of the blend are present within the blend in different spatial domains, which interpenetrate each other.

Polyglycolic acid, also as known as polyglycolide, is a biodegradable, thermoplastic polymer and the simplest linear, aliphatic polyester. It can be prepared starting from glycolic acid by means of polycondensation or from glycolide by ring-opening polymerization.

Polyglycolic acid includes homopolymer of glycolic acid (inclusive of a ring-opening polymerization product of glycolide, which is a bimolecular cyclic ester of glycolic acid) consisting only of glycolic acid repeating unit represented by a formula of —(O—CH₂—CO)— and also a glycolic acid copolymer containing at least 70% by weight of the above-mentioned glycolic acid repeating unit.

Examples of comonomers for providing the polyglycolic acid copolymer together with the glycolic acid monomer such as glycolide, may include, but are not limited to: cyclic monomers, inclusive of ethylene oxalate (i.e., 1,4-dioxane-2,3-dione); lactides; lactones, such as β-propiolactone, β-butyrolactone; pivalolactone, γ-butyrolactone, δ-valerolactone, β-methyl-δ-valerolactone, and ε-caprolactone; carbonates, such as trimethylene carbonate; ethers, such as 1,3-dioxane; ether-esters, such as dioxanone; and amides, such as ε-caprolactam; hydroxycarboxylic acids, such as lactic acid, 3-hydroxypropanoic acid, 4-hydroxybutanonic acid and 6-hydroxycaproic acid, and their alkyl esters; substantially equal molar mixtures of aliphatic diols, such as ethylene glycol and 1,4-butane diol with aliphatic dicarboxylic acids, such as succinic acid and adipic acid, and their alkyl or aromatic esters; and two or more species of these. These monomers may be replaced by polymers thereof, which can be used as a starting material for providing a polyglycolic acid copolymer together with the above-mentioned glycolic acid monomer such as glycolide.

The above-mentioned glycolic acid repeating unit should occupy at least 70% by weight, preferably at least 90% by weight, of the polyglycolic acid. If the content is too small, the strength or the gas-barrier property expected of polyglycolic acid becomes scarce. As far as this is satisfied, the polyglycolic acid can comprise two or more species of polyglycolic acid (co)polymers in combination.

Polyglycolic acid may preferably have a molecular weight Mw (weight-average molecular weight based on polymethyl methacrylate) in the range of 3×10⁴ to 8×10⁵, particularly 5×10⁴ to 5×10⁵, as measured by GPC measurement using hexafluoroisopropanol solvent. If the molecular weight is too small, the polyglycolic acid can be expected to show an insufficient strength in the application. On the other hand, too large a molecular weight is liable to result in difficulties in melt-extrusion, forming and processing.

Polyglycolic acids preferably have a melt volume rate (MVR) according to EN ISO 1133 (240° C., 2.16 kg weight) in the range of 0.1 to 70 cm³/10 min, preferably 0.8 to 70 cm³/10 min, more preferably 1 to 60 cm³/10 min.

### Polycaprolactone c)

The biodegradable polymer blend according to the invention comprises 2 to 72% by weight, particularly 5 to 50% by weight, especially 5 to 30% by weight, based on the total weight of polyester a), polymer b) and polycaprolactone c), of at least one polycaprolactone c) having a viscosity number (VN) of at least 110 ml/g, as determined according to DIN 53728-3:1985-1. The viscosity number is determined at 25° C. using a solution of the respective polymer in a 50:50 w/w mixture of phenol and 1,2-dichlorobenzene.

Polycaprolactone, more precisely poly-ε-caprolactone, is a class of linear aliphatic polyesters obtained by the ring-opening polymerization of w-caprolactone monomers under the catalysis of metal-organic compounds (such as tetraphenyltin). Generally, polycaprolactone has a melting point of 59 to 64° C. and a glass transition temperature of −60° C. Its structural repeating unit has 5 non-polar methylene-CH₂— and one polar ester group —COO—, namely —(COOCH₂CH₂CH₂CH₂CH₂—)ₙ. This structure makes polycaprolactone have good flexibility processability, and at the same time, good biocompatibility.

Polycaprolactone is commercially available for example from Daicel under the product name Placcel®, or from Ingevity under the product name Capa™ 6400, Capa™ 6500, Capa™ 6800. The viscosity number (VN) of the polycaprolactone c) is in particular at least 150 ml/g, preferably at least 200 ml/g, especially at least 250 ml/g, as determined according to DIN 53728-3:1985-1. In a particular group of embodiments, the VN of the polycaprolactone c) is in the range of 150 to 600 ml/g, preferably in the range of 200 to 500 ml/g, especially 250 to 450 ml/g, as determined according to DIN 53728-3:1985-1.

The number average molecular weight (Mn) of the polycaprolactone c) is generally at least 20000 g/mol, in particular at least 25000 g/mol, preferably at least 28000 g/mol, especially at least 31000 g/mol, as determined by GPC. In particular, the Mn of the polycaprolactone c) is in the range of 20000 to 200000 g/mol, in particular in the range of 25000 to 170000 g/mol, preferably 28000 to 150000 g/mol, especially 31000 to 100000 g/mol, as determined by GPC.

The weight average molecular weight (Mw) of the polycaprolactone c) is generally at least 50000 g/mol, in particular at least 70000 g/mol, preferably at least 80000 g/mol, especially at least 115000 g/mol, as determined by GPC and e.g. in the range of 50000 to 500000 g/mol, in particular in the range of 70000 to 350000 g/mol, preferably in the range of 80000 to 300000 g/mol, especially in the range of 115000 to 250000 g/mol.

The polydispersity, which is the ratio of Mw to Mn (Mw/Mn), of the polycaprolactone c) is generally in the range of 1.0 to 6.0, in particular in the range of 1.5 to 5.5, preferably in the range of 2.0 to 5.2, especially in the range of 2.2 to 5.0.

The melting point of suitable polycaprolactone is usually in the range of 40 to 70° C., particularly 50 to 65° C., preferably 55 to 65° C., as determined by DSC. In particular, polycaprolactones having an MVR according to EN ISO 1133 (160° C., 2.16 kg weight) in the range of 1 to 30 cm³/10 min, preferably 1 to 20 cm³/10 min, especially 1 to 10 cm³/10 min are suitable.

The weight ratio of polyester a) to the sum of polymer b) and polycaprolactone c) (polyester a:(polymer b+polycaprolactone c)) is in the range of 10:90 to 80:20, preferably 15:85 to 50:50, more preferably 20:80 to 45:55.

The weight ratio of polymer b) to polycaprolactone c) is in the range of 9:1 to 1:4, preferably 9:1 to 1:3, more preferably 9:1 to 1:2.

The amount of polyester a) is particularly in the range of 15 to 50% by weight, especially 20 to 40% by weight, the amount of polymer b) is particularly in the range of 35 to 70% by weight, especially 40 to 70% by weight, and the amount of the polycaprolactone c) is particularly in the range of 5 to 50% by weight, especially 5 to 30% by weight, based on the total weight of polyester a), polymer b) and polycaprolactone c).

The total weight of polyester a), polymer b) and polycaprolactone c) is at least 50% by weight, in particular at least 60% by weight, especially at least 65% by weight or at least 70% by weight, based on the total weight of the blend.

### The Biodegradable Polymer Blend

The biodegradable polymer blend according to the invention has a high biodegradability in combination with good film properties.

The biodegradable polymer blend generally has a melt volume rate (MVR) in the range of 0.5 to 35 cm³/10 min, preferably in the range of 1 to 30 cm³/10 min, more preferably in the range of 1.5 to 25 cm³/10 min according EN ISO 1133 (190° C., 2.16 kg weight).

The blend may also have a melt volume rate (MVR) which is in the range of 5 to 35 cm³/10 min, in particular in the range of 10 to 30 cm³/10 min, especially in the range of 14 to 25 cm³/10 min according EN ISO 1133 (190° C., 2.16 kg weight), in particular if the blend is intended for laminating or paper coating.

The blend may also have a melt volume rate (MVR) which is in the range of 2 to 35 cm³/10 min, in particular in the range of 3 to 30 cm³/10 min, especially in the range of 5 to 25 cm³/10 min according EN ISO 1133 (190° C., 2.16 kg weight), in particular if the blend is intended for injection molding.

The blend may also have a melt volume rate (MVR) which is in the range of 0.5 to 15 cm³/10 min, in particular in the range of 1 to 12 cm³/10 min, especially in the range of 1.5 to 10 cm³/10 min according EN ISO 1133 (190° C., 2.16 kg weight), in particular if the blend is intended for thermoforming.

In addition to components a), b) and c), the polymer blend may further comprise further components other than the polymer components a), b) and c). These components are hereinafter termed component d) and include but are not limited to
d1) one or more filler as component d1);
d2) plasticizers as component d2) and
d3) one or more additives other than plasticizers d2) as component d3), which are other than fillers d1), such as stabilizers, nucleating agents, lubricants and release agents, surfactants, wax, antistatic agents, antifogging agents, dyes, pigments, UV absorbers, UV stabilizers and mixtures thereof.

The total amount of component d) may be as high as 50% by weight, particularly up to 40% by weight, especially up to 35% or up to 30% by weight, based on the total weight of the blend.

In an embodiment, the thermoplastic polymer blend optionally comprises from 0 to 38% by weight, particularly from 0 to 30% by weight, especially from 0 to 29% by weight, based on the total weight of the blend, of one or more fillers (component (d1)).

Suitable fillers include, but are not limited to native or plasticized starch, natural fibers, wood meal and/or an inorganic filler selected from the group consisting of chalk, precipitated calcium carbonate, graphite, gypsum, conductive carbon black, iron oxide, calcium chloride, dolomite, kaolin, silicon dioxide (quartz), sodium carbonate, titanium dioxide, silicate, wollastonite, mica, montmorillonite, talc, glass fibers and mineral fibers and are added. Starch and amylose may be native, i.e. non-thermoplasticized or thermoplasticized with plasticizers, such as, for example, glycerol or sorbitol (EP-A 539 541, EP-A 575 349, EP 652 910). Natural fibers are understood as meaning, for example cellulose fibers, hemp fibers, sisal, kenaf, jute, flax, abacca, coconut fibers or Cordenka fibers. Glass fibers, carbon fibers, aramid fibers, potassium titanate fibers and natural fibers may be mentioned as preferred fibrous fillers, glass fibers as E-glass being particularly preferred. These can be used as rovings or in particular as cut glass in the commercially available forms. These fibers have in general a diameter of from 3 to 30 μm, preferably from 6 to 20 μm and particularly preferably from 8 to 15 μm. The fiber length in the compound is as a rule from 20 μm to 1000 μm, preferably from 180 to 500 μm and particularly preferably from 200 to 400 μm.

The biodegradable polymer blend may also comprise plasticizers d2), for example, citric esters (in particular acetyl tributyl citrate), glyceryl esters, such as triacetin, or ethylene glycol derivatives. Plasticizers may be present in an amount of from 0 to 10% by weight, in particular 0 to 8.5% by the weight, especially 0 to 5% by the weight, based on the total weight of the polymer blend.

In one embodiment, the biodegradable polymer blend optionally comprises from 0 to 2% by weight, particularly 0 to 1.5% by weight, especially 0 to 1% by weight, based on the total weight of the blend, of at least one component d3), which is typically selected from the group consisting of stabilizers, nucleating agents, lubricants and release agents, surfactants, wax, antistatic agents, antifogging agents, dyes, pigments, UV absorbers, UV stabilizers and mixtures thereof.

Particularly preferably, the biodegradable polymer blend comprises 0.1 to 30% by weight, based on the total weight of the polymer blend, of the component d) which is selected from the group consisting of mineral fillers, plasticizers, nucleating agents, UV stabilizers, carbon black, antiblocking agents, antifogging agents, slip agents (lubricants), chain extenders, starch, cellulose, waxes and mixtures thereof.

Suitable nucleating agents include, but are not limited to polybutylene terephthalate, N,N′-ethylenebisstearylamide, zinc phenylphosphonate, graphite, talc, chalk, precipitated calcium carbonate, kaolin, quartz sand or silicate.

Suitable release agents include, but are not limited to stearates (in particular calcium stearate, erucamide, behenamide and stearamide).

Suitable surfactants include, but are not limited to polysorbates, palmitates and laurates.

Suitable waxes include, but are not limited to erucamide, stearamide, behenamide, montan wax, beeswax or beeswax esters, plant based waxes like e.g., candelilla wax or carnauba wax.

In particular, the polymer blend optionally comprises
d1) from 0 to 38% by weight, particularly 0 to 30% by weight, especially 0 to 29% by weight, based on the total weight of the blend, of the component d1); and
d2) from 0 to 10% by weight, particularly 0 to 8.5% by weight, especially 0 to 5% by weight, based on the total weight of the blend, of one or more plasticizers d2);
d3) from 0 to 2% by weight, particularly 0 to 1.5% by weight, especially 0 to 1% by weight, based on the total weight of the blend, of the component d3), which is in particular selected from stabilizers, lubricants and release agents, surfactants, wax, antistatic agents, antifogging agents, dyes, pigments, UV absorbers, UV stabilizers and combinations thereof.

In a group of embodiments, the component d1), d2) and/or d3) is given to the polymer blend during and/or after producing of the polymer blend.

In another group of embodiments, the component d1), d2) and/or d3) is already incorporated in the polyester a). The above-mentioned amounts of component d1) and d2) apply also to this group of embodiments.

The mono-layered or multi-layered film of the invention can moreover comprise further additives known to the person skilled in the art. Examples are the additional substances conventionally used in plastics technology, e.g. stabilizers; nucleating agents; lubricants and release agents such as stearates (in particular calcium stearate); plasticizers such as citric esters (tributyl acetylcitrate), glycerol esters such as triacetin, or ethylene glycol derivatives, surfactants such as polysorbates, palmitates, or laurates: waxes such as erucamide, stearamide, behenamide, beeswax, beeswax esters, candelilla, carnauba, or montan wax; antistatic agents, UV absorbers; UV stabilizers; antifogging agents, or dyes. The concentrations of the additives other than plasticizers (component d3)) are usually from 0 to 2% by weight, in particular from 0 to 1.5% by weight, especially 0 to 1% by weight, based on the total weight of the film of the invention. The film of the invention can comprise from 0.1 to 10% by weight of plasticizers, based on the total weight of the film of the invention.

The preparation of the biodegradable polymer blend from the individual components can be effected by known processes (EP 792 309 and U.S. Pat. No. 5,883,199). For example, all components of the mixture can be mixed in one process step in the mixing apparatuses known to the person skilled in the art, for example kneaders or extruders, at elevated temperatures, for example from 120° C. to 300° C.

Preferably, the biodegradable polymer blend comprises
10 to 80% by weight, in particular 15 to 50% by weight, especially 20 to 40% by weight, based on the total weight of polyester a), polymer b) and polycaprolactone c), of at least one biodegradable polyester a), as defined herein, where the polyester a) in particular comprises at least 50% by weight, especially at least 70% by weight, or at least 80% by weight, or at least 90% by weight, and may be as high as 100% by weight, based on the total weight of polyester a), of an aliphatic-aromatic polyester;
18 to 88% by weight, in particular 35 to 70% by weight, especially 40 to 70% by weight, based on the total weight of polyester a), polymer b) and polycaprolactone c), of at least one polymer b), as defined herein;
2 to 72% by weight, in particular 5 to 50% by weight, especially 5 to 30% by weight, based on the total weight of polyester a), polymer b) and polycaprolactone c), of at least one polycaprolactone c) having a viscosity number of particularly at least 150 ml/g, preferably in the range of 200 to 500 ml/g, especially 250 to 450 ml/g, as determined according to DIN 53728-3:1985-1,
   wherein the total weight of polyester a), polymer b) and polycaprolactone c) is at least 50% by weight, in particular at least 60% by weight, especially at least 65% by weight or at least 70% by weight, based on the total weight of the blend. The remainder, if any, is typically selected from the components d1), d2) and d3).

Especially, the biodegradable polymer blend comprises
10 to 80% by weight, in particular 15 to 50% by weight, especially 20 to 40% by weight, based on the total weight of polyester a), polymer b) and polycaprolactone c), of at least one biodegradable polyester a), as defined herein, where the polyester a) in particular comprises at least 50% by weight, especially at least 70% by weight, or at least 80% by weight, or at least 90% by weight, and may be as high as 100% by weight, based on the total weight of polyester a), of an aliphatic-aromatic polyester;
18 to 88% by weight, in particular 35 to 70% by weight, especially 40 to 70% by weight, based on the total weight of polyester a), polymer b) and polycaprolactone c), of at least one polymer b) selected from the group consisting of polylactides and mixtures thereof;
2 to 72% by weight, in particular 5 to 50% by weight, especially 5 to 30% by weight, based on the total weight of polyester a), polymer b) and polycaprolactone c), of at least one polycaprolactone c) having a viscosity number of particularly at least 150 ml/g, preferably in the range of 200 to 500 ml/g, especially 250 to 450 ml/g, as determined according to DIN 53728-3:1985-1,
   wherein the total weight of polyester a), polymer b) and polycaprolactone c) is at least 50% by weight, in particular at least 60% by weight, especially at least 65% by weight or at least 70% by weight, based on the total weight of the blend. The remainder, if any, is typically selected from the components d1), d2) and d3).

In a preferred group (A) of embodiments, the biodegradable polymer blend comprises
50% to 90% by weight, in particular 60% to 87% by weight, especially 65% to 82% by weight or 70% to 82% by weight, based on the total weight of the blend, of polyester a), polymer b) and polycaprolactone c); and
10 to 40% by weight, particularly 13 to 38% by weight, especially 18 to 35% by weight, or 18 to 30% by weight, based on the total weight of polyester a), polymer b) and polycaprolactone c), of one or more fillers (component d1));
wherein the remainder, if any, is typically selected from the component d3).

In a particularly preferred group (A.1) of the group (A), the biodegradable polymer blend comprises
50% to 90% by weight, in particular 60% to 85% by weight, especially 65% to 78% by weight or 70% to 82% by weight, based on the total weight of the blend, of polyester a), polymer b) and polycaprolactone c);
10 to 40% by weight, particularly 15 to 38% by weight, especially 22 to 35% by weight, or 18 to 30% by weight based on the total weight of polyester a), polymer b) and polycaprolactone c), of one or more fillers (component d1)); and
0 to 2% by weight, particularly 0 to 1.5% by weight, especially 0 to 1% by weight or 0 to 0.5 by weight, based on the total weight of the blend, of one or more components d3).

In another particularly preferred group (A.2) of the group (A), the biodegradable polymer blend comprises
50% to 90% by weight, in particular 60% to 86% by weight, especially 65% to 81% by weight or 70% to 81% by weight, based on the total weight of the blend, of polyester a), polymer b) and polycaprolactone c);
10 to 40% by weight, particularly 13 to 35% by weight, especially 18 to 30% by weight, or 18 to 29% by weight, based on the total weight of polyester a), polymer b) and polycaprolactone c), of one or more fillers (component d1)); and
0 to 2% by weight, particularly 0.1 to 1.5% by weight, especially 0.2 to 1% by weight, based on the total weight of the blend, of one or more components d3).

The biodegradable polymer blends according to this preferred group (A) of embodiments are particularly suitable to be processed by a manufacturing method such as thermoforming or injection molding. Thermoforming is a manufacturing process where a plastic sheet is heated to a pliable forming temperature typically below its melting temperature, formed to a specific shape in a mold, and trimmed to create a usable product. Injection molding is a manufacturing process for producing parts by injecting molten material such as thermoplastic and thermosetting polymers into a mold.

The biodegradable polymer blends according to the group (A) are particularly suitable for producing rigid packaging.

Particularly, the biodegradable polymer blends according to the group (A.1) are particularly suitable for producing rigid packaging by thermoforming.

Also particularly, the biodegradable polymer blend according to the group (A.2) are particularly suitable for producing rigid packaging by injection molding.

Optionally, the biodegradable polymer blends comprise at least one compatibilizer. If present, the amount of the compatibilizer is frequently from 0.05 to 2% by weight, based on the total weight of the polymer blend. Preferred compatibilizers are additives containing carboxylic anhydrides, such as maleic anhydride grafted (co-)polymers of poly(butylene adipate-co-terephthalate), and in particular the above-described copolymers containing epoxide groups and based on styrene, acrylates and/or methacrylates. The units carrying epoxide groups are preferably glycidyl (meth)acrylates. Copolymers of the abovementioned type which contain epoxide groups are sold, for example, by BASF under the brand Joncryl® ADR. For example, Joncryl® ADR 4468 and Joncryl® ADR 4400 are particularly suitable as a compatibilizer.

Optionally, the biodegradable polymer blend comprises:
from 50 to 95% by weight, particularly from 60 to 90% by weight, especially from 70 to 88% by weight, based on the total weight of the blend, of polyester a), polymer b) and polycaprolactone c); and
if present, from 0.05 to 2% by weight, based on the total weight of the blend, of at least one compatibilizer, in particular of at least one poly(meth)acrylate containing epoxide groups.

The polymer blends may be used as dry blends or as compounds.

The biodegradable polymer blend according to the invention is suitable for producing mono-layered films and multilayered films and for coating a substrate layer. As mentioned above, the inventive polymer blend improves adhesion at high coating lines speed.

The present invention, hence, relates to mono-layered films and multilayered films comprising or consisting of at least one layer comprising or consisting of the biodegradable polymer blend, as defined herein. The present invention also relates to the use of the biodegradable polymer blend, as defined herein, for coating a substrate layer.

Throughout the specification, the term “a mono-layered film” is to be understood as a film comprising only a single layer and “a multilayered film” is to be understood as a film comprising at least two layers, respectively. In this context, such multilayer film does not necessarily include a substrate layer, on to which the film can be coated.

For the production of mono-layered and multilayered films according to the invention, cast film extrusion, blown film extrusion, extrusion coating and lamination methods are suitable. A combination of these methods is also conceivable.

The inventive biodegradable polymer blend is suitable for coating a substrate layer with a monolayer, which is also known as a single-layer coating, as well as for coating a substrate with more than one layer, i.e. multilayers, which is also known as a multilayer coating.

The average grammage in case of single-layer coating is generally 5 to 50 and preferably 10 to 30 g/m² and in case of multilayer coating is generally 10 to 60 and preferably 15 to 35 g/m².

The grammage is determined by means of punched roundels, which have in general a diameter of 4.5 inches (114.3 mm). The roundels are weighed both before and after coating. From the difference in weight and from the known area it is possible to report the grammage in g/m².

Multilayer coating is an entirely conventional method particularly in paper or cardboard coating. As a rule, from 2 to 7 layers and preferably 2 or 3 layers are applied as coating layers. Multilayer coating offers the possibility of individually optimizing the welding properties, the barrier properties, and the adhesion of the coating to substrate layer for the coating layers. Furthermore, a mono- or multilayer could serve as primer layer for subsequent coatings of laminations, for example, providing good adhesion or a smooth surface or both.

Thus, an outer layer or top layer of multilayer coatings must as a rule be, for example, scratch-resistant and thermally stable and have little tack. The tendency to exhibit tack must be reduced simply to avoid the film sticking to the chill roll in the production process.

In a particular embodiment, said outer layer comprises 80 to 100% by weight, especially 85 to 99.9% by weight, in particular 90 to 99% by weight, based on the total weight of the outer layer, of the biodegradable polymer blend, as defined herein, and optionally 0 to 20% by weight, if present 0.3 to 13% by weight, in particular 3 to 10% by weight, based on the total weight of the outer layer, of wax formulation comprising a wax, a dispersant and an antiblocking agents.

The wax formulation preferably comprises 0 to 5% by weight, especially 0.1 to 4% by weight, in particular 1 to 3% by weight, based on the total weight of the outer layer, of wax, 0 to 10% by weight, especially 0.1 to 5% by weight, in particular 1 to 4% by weight, based on the total weight of the outer layer, of dispersant, and 0 to 5% by weight, especially 0.1 to 4% by weight, in particular 1 to 3% by weight, based on the total weight of the outer layer, of antiblocking agent.

Suitable examples of the wax, the dispersant and the antiblocking agent used in the wax formulations and preferences thereof are as described above.

Suitable examples of the dispersants used in the wax formulation are, but not limited to metal salts of stearic acid, oleic acid, N,N′-ethylenebisstearamide, fatty acid amides, e.g. erucamide, oleamide.

Suitable examples of the antiblocking agent used in the wax formulation are, but not limited to calcium carbonate, silica, talc, behenamide, stearamide, N,N′-ethylene-bis-oleamide.

If the multilayer coating comprises at least three layers, a layer between the outer layer and the layer coated directly on to the substrate is referred to as a middle layer. The middle layer is as a rule stiffer and may also be referred to as a substrate layer or barrier layer. In paper coating with thin films, the middle layer can also be completely dispensed with.

At least one layer comprises at least one aliphatic-aromatic polyester. Suitable examples of the aliphatic-aromatic polyester used in at least one layer are, but not limited to the aliphatic-aromatic polyesters as described above. Particular preference is given to aliphatic-aromatic polyesters selected from poly(butylene adipate-co-terephthalate) (PBAT), poly(butylene sebacate-co-terephthalate) (PBSeT), poly(butylene azelate-co-terephthalate) (PBAzT), poly(butylene adipate-co-furanoate) (PBAF), poly(butylene sebacate-co-furanoate) (PBSeF), poly(butylene azelate-co-furanoate) (PBAzF), poly(butylene adipate-co-sebacate-co-terephthalate) (PBASeT), poly(butylene adipate-co-azelate-co-furanoate) (PBAAzF), poly(butylene adipate-co-azelate-co-terephthalate) (PBAAzT), poly(butylene succinate-co-furanoate) (PBSF) and poly(butylene adipate-co-sebacate-co-furanoate) (PBASeF).

The inner layer is the layer in contact with the substrate layer. Therefore, it should, as a rule, be soft and adhere well to the substrate layer.

Suitable examples of the aliphatic-aromatic polyester used in the middle layer and in the inner layer and preferences thereof are as described above.

The present invention also relates to a process for coating a substrate layer comprises steps:
step A) providing a substrate layer, and
step B) coating the substrate by at least one layer comprising the biodegradable polymer blend, as defined herein.

The step B), i.e. coating of the substrate by at least one layer comprising the biodegradable polymer blend, as defined herein, is preferably carried out by extrusion coating, coextrusion coating or lamination such as extrusion lamination or adhesive lamination, in particular by extrusion coating or coextrusion coating.

Extrusion coating and coextrusion coating were developed in order to apply thin polymer layers to flexible substrates, such as paper, cardboard or multilayer films comprising a metal layer at high web speeds of 100-600 m/min. The biodegradable polymer blend, as described herein, can be processed by existing extrusion coating plants for polyethylene, as described in J. Nentwig: Kunststofffolien, Hanser Verlag, Munich 2006, page 195; H. J. Saechtling: Kunststoff Taschenbuch, Hanser Verlag, Munich 2007, page 256; C. Rauwendaal: L Polymer Extrusion, Hanser Verlag, Munich 2004, page 547.

Lamination is a method to produce a composite system with improved strength, stability and appearance by using two or more materials, for example a substrate layer and a film layer or two film layers, which are assembled using heat, pressure, welding, or adhesives. Suitable lamination method for bonding a substrate layer and at least one film layer or two or more films to give a laminate are extrusion lamination and adhesive lamination. The inventive polymer blend can be processed using lamination as known to a skilled person in the art.

In general, any material can be served as a substrate layer, as long as it is suitable to be applied in the process according to the invention. Examples of the suitable substrate layers include, but are not limited to fiber-based substrates, such as paper, cardboard, paperboard or fiber board. In this context, raw materials for the paper, the cardboard and the fiber board may not only be wood, wood products or recycled pulp but may also be other plant fibers. Suitable examples for the other plant fibers include but are not limited to fibers from sugar cane, bamboo, grass or silphia.

The substrate layer is preferably a fiber-based substrate, such as paper, cardboard, paperboard or fiber board, in particular paper.

In particular, the step B) is carried out by coating the substrate layer with more than one layer, i.e. multilayer, comprising the biodegradable polymer blend, as defined herein, using extrusion coating, coextrusion coating, lamination such as extrusion lamination or adhesive lamination, or thermoforming, preferably coextrusion coating, wherein the substrate layer is a fiber-based substrate, especially paper or cardboard.

In particular, the coating in step B) is carried out by extrusion coating, coextrusion coating, lamination with mono- or multilayer film or thermoforming.

In a preferred embodiment, the step B is carried out by coating the substrate layer with at least one layer comprising the biodegradable polymer blend, as defined herein, and optionally with one or more further layers formed by biodegradable materials other than the biodegradable polymer blend, as defined herein, in one of the layers.

Suitable examples of the biodegradable materials other than the biodegradable polymer blend, as defined herein, are for example but not limited to metallized or otherwise inorganically coated biodegradable polymer films, cellophane, PLANTIC™ barrier film sold by Kuraray, polyvinyl alcohol (PVOH), particularly PVOH commercially available under the trade name G-Polymer™, ethylene vinyl alcohol (EVOH), hydrolyzed polyvinyl acetate (PVOAc), and polyglycolic acid (PGA) and copolymers thereof.

The advantages mentioned above also apply to a laminate comprising at least one film according to the invention. Therefore, the present invention further relates to a laminate comprising at least one film according to the invention and a substrate onto which the film is laminated. Moreover, the present invention relates to a laminate, which is obtainable by the process for coating a substrate layer, as defined herein.

Throughout the specification, the terms “laminate” is to be understood as a composite system that is produced with a lamination method by using two or more materials, for example a substrate layer and a film layer or two film layers, which are assembled using heat, pressure, welding, or adhesives.

Especially, the step B) and/or lamination can be carried out using heat and pressure to achieve a desired shape (thermoforming). Thermoforming is a common lamination method for paper packaging, in which heat and pressure are used to simultaneously shape the substrate incl. the film.

In the context of the present invention, a laminate can comprise one or more substrate layers and one or more film layers together or either solely one or more substrate layer or solely one or more film layer.

One or more film layers may be barrier layer that inhibits the permeation of gases present in atmosphere, e.g. O₂ or N₂, and/or in particular of moisture or liquids.

Examples of such barrier layers include but are not limited to metallic layers and layers comprising or consisting of waxes; metal oxides such as silicon oxide or aluminum oxide; lignin and/or oligo- or polysaccharides; proteins; and ethylene-vinyl alcohol copolymers, e. g. hydrolyzed ethylene vinyl acetate copolymers. Preferably, such barrier layers should be compostable.

The process according to the invention is suitable for coating a substrate used for the production of packaging, such as packaging for food, for beverages, for nutritional products, for personal-care products, for cleaning and washing agents; paper and cardboard cups and plates; carrier bags; paper adhesive tape; paper labels; flower pots; and plant pots.

Hence, the present invention also relates to a material, which is selected from packaging, such as packaging for food, for beverages, for nutritional products, for personal-care products, for cleaning and washing agents; paper and cardboard cups and plates; carrier bags; paper adhesive tape; paper labels; flower pots; and plant pots, where the material comprises at least one film according to the invention or a laminate, as defined herein.

Furthermore, the process according to the invention is particularly suitable for coating paper for the production of paper bags for dry foods, such as, for example, coffee, tea, soup powders, sauce powders; for liquids, such as, for example, cosmetics, cleaning agents, beverages; of tube laminates; of paper carrier bags; of paper laminates and coextrudates for ice cream, confectionery (e.g. chocolate bars and muesli bars), of paper adhesive tape; of cardboard cups (paper cups), yoghurt pots; of meal trays; of wound cardboard containers (cans, drums), of wet-strength cartons for outer packagings (wine bottles, food); of fruit boxes of coated cardboard; of fast food plates; of clamshells; of beverage cartons and cartons for liquids, such as detergents and cleaning agents, frozen food cartons, ice packaging (e.g. ice cups, wrapping material for conical ice cream wafers); of paper labels; of flower pots and plant pots.

The blends of the present invention can also be used in rigid packaging applications. In contrast to flexible packaging, rigid packaging is understood as packaging having a defined shape. Therefore, a further aspect of the present invention relates to the use of the blends as defined herein in the production of rigid packaging articles.

Rigid packaging is usually produced by thermoforming of a sheet or laminate comprising the blend of the present invention or by injection molding of the blend of the present invention. Thermoforming and injection molding may be carried out by analogy to well known processes of thermoforming and injection molding, respectively, of thermoplastic materials.

In thermoforming, the sheet or laminate may consist of plastic materials comprising one or more layers formed by the blend of the present invention. However, it is also possible to produce rigid packaging by thermoforming a sheet or laminate comprising a base layer made of a fibrous material, e. g. a paper or cardboard layer, which is coated with one or more thermoplastic layers comprising at least one layer of the blend according to the present invention. The sheets or laminates used in the production for rigid packaging by thermoforming preferably have at least one outer layer which is formed by the blend of the present invention. The sheets or laminates used in the production for rigid packaging by thermoforming preferably have at least one barrier layer, for example a laminate can be used which has an ABC structure, where A and C refer to layers formed by the blend of the present invention but do not necessarily have to be identical while B refers to a barrier layer. Comparable ABC structured rigid packaging articles can also be prepared by injection molding, for example by co-injection molding.

Therefore, the present invention also relates to a method for producing rigid packaging articles which comprises shaping a polymer blend of the present invention or a mono- or multilayer sheet or laminate comprising a polymer blend of the present invention by thermoforming or injection molding.

### EXAMPLES

The invention is elucidated in more detail by the examples hereinafter.

### 1 Analytics

### 1.1 Measurements of Performance Characteristics

The seal strengths of the paper substrates coated with the polymer films were determined using Kopp sealing device LM 3000 at a pressure of 500 bar with a dwell time of 0.2 s. Two different sealing times of 0.2 s and 0.5 s were applied for Sappi and CFN paper, respectively. A haul-off speed was 12 m/min.

The evaluation of adhesion was carried out by a trained person. Firstly, the trained person stripped away the applied polymer coating from the paper substrate using the own hand. Then, the resulting tear-off area of previously bonded paper substrate and polymer film was evaluated with regard to fiber breakage or fiber adhesion according to the adjacent scheme. The evaluation of adhesion was rated with a scale of 1 to 5, wherein 0=“no adhesion”, 1=“a bit sticking”, 2=“some torn fibers”, 3=“under 50% fiber tear”, 4=“over 50% fiber tear”, 4.5=“over 90% fiber tear”, 5=“100% fiber tear; a “perfect” adhesion”.

### 1.2 Max. Line Speed

To determine max. line speed (m/min), the plant is started up slowly at first and the plant speed is successively increased. It is observed up to which speed coating is possible.

### 1.3 Viscosity Number (VN) of PCL

As described above, the viscosity number (VN) was determined according to DIN 53728-3:1985-1. The viscosity number is determined at 25° C. using a solution of the respective polymer in a 50:50 w/w mixture of phenol and 1,2-dichlorobenzene.

### 1.4 Number Average Molecular Weight (Mn)

As described above, the Mn was determined by GPC with an RI (refractive index) detector, using a mixture of hexafluoroisopropanol and 0.05% potassium trifluoroacetate as an eluent (temperature: 40° C., flow rate: 1 mL/min) and polymethyl methacrylate of defined molecular weight as standards for calibration.

### 1.5 MVR

The MVR (melt volume rate) of the polymers and polymer blends was measured according to EN ISO 1133 at 190° C. with a weight of 2.16 kg if not indicated otherwise.

### 1.6 E Modulus

E modulus was determined according to ISO 527-2:2012 on dumbbell shaped specimens with a thickness of approx. 3.95 mm (specimen type 1A) at 23° C. at 50% relative humidity.

### 1.7 Heat Deflection Temperature (HDT/B)

Heat deflection temperature (HDT/B) was determined according to DIN EN ISO 75-2:2004-9 using a flatwise orientation of 80 mm×10 mm×4 mm specimens. Method B was used involving 0.45 MPa stress and a temperature ramping rate of 120 K/h.

### 2 Experimental Setup

### 2.1 Paper Coatings

The extruder setup of the pilot coating plant is equipped with four separate extruders two of which were used to perform the experiments (extruders A and B)—see Table A. The feed of the single extruders can be selected with a selector plug which allows the application of multilayer structures of up to 5 layers and encapsulation. For monolayer coatings only the feed of main extruder A was used. The polymer melt is fed onto the substrate via an internally deckled extrusion T-type die (Cloern EBR™ III A) with edge encapsulation.

TABLE A
Extruder setup

| | Main Extruder A | Extruder B |
|---|---|---|
| Screw | 60 mm diameter; L/D = 30 | 40 mm diameter; L/D = 24 |
| Rotational | 130 rpm (Monolayers) | 120 rpm (Bilayers) |
| speed | 80 rpm (Bilayers) | |
| max. Output | 90 kg/h | 30 kg/h |

The paper substrates used were Sappi Magnostar (“Sappi”) with a grammage of 58 g/m² and Cupforma Natura by Stora Enso (“CFN”) with a grammage of 195 g/m². paper, and their width was 500 mm. The substrate was activated by Corona treatment (3.2 kV).

All coatings were extruded onto the paper substrates at a melt temperature of 235 to 260° C. The temperature profile zones 1 to 7 had a temperature of 170° C., 195° C., 210° C., 230 to 240° C., 220 to 240° C., 220 to 240° C. and 220 to 240° C., respectively. The pressure at nozzle was 100 bar and the normal contact pressure on the chill roll was 6 bar. The chill roll was glossy. Throughput was kept constant, the speed of the substrate was increased stepwise from 80 to 360 m/min.

### 2.2 Production of Polymer Blends

### Polymers Used for Producing the Blends:

### Polyester 1:

A poly(butylene sebacate-co-terephthalate) having an MVR (190° C., 2.16 kg) of 6+/−2 cm³/10 min according to EN ISO 1133 (190° C., 2.16 kg weight).

### Polyester 2:

A poly(butylene adipate-co-terephthalate) available from BASF SE as ecoflex F Blend C1300 having an MVR (190° C., 2.16 kg) of 10+/−2 cm³/10 min according to EN ISO 1133 (190° C., 2.16 kg weight).

### Polylactide (PLA):

A biopolymer comprising polylactide with an MVR (190° C., 2.16 kg) of 32 to 38 g/10 min. It is commercially available from Natureworks under the brand Ingeo™ 3251D.

### Polycaprolactone 1 (PCL 1):

A high molecular weight linear polyester derived from caprolactone monomer having a viscosity number of 375.5 ml/g, as determined according to DIN 53728-3:1985-1 and Mn of 39000 g/mol, as determined by GPC. It is commercially available from Ingevity under the brand Capa™ 6800.

### Polycaprolactone 2 (PCL 2):

A high molecular weight linear polyester derived from caprolactone monomer having a viscosity number of 137.5 ml/g, as determined according to DIN 53728-3:1985-1 and Mn of 24000 g/mol, as determined by GPC. It is commercially available from Ingevity under the brand Capa™ 6400.

### Polycaprolactone 3 (PCL 3):

A high molecular weight linear polyester derived from caprolactone monomer having a viscosity number of 224.1 ml/g, as determined according to DIN 53728-3:1985-1 and Mn of 30000 g/mol, as determined by GPC. It is commercially available from Ingevity under the brand Capa™ 6500.

### Filler:

A talc powder commercially available from Elementis under the brand Plustalc H05C.

### Additive:

An erucamide commercially available from Croda under the brand Crodamide™ ER.

All blends were prepared by extrusion carried out with Coperion ZSK 26 MC twin-screw extruder (11 Zones; Zone 2=140° C., Zones 3-11=190° C.) at a rotational speed of 300 rpm. Individual components were dosed via separate gravimetric scales in zone 1, and molten and mixed in the following zone. The polymer melt was degassed in zone 9 at 600 mbar. The temperature at the die plate was between 215 and 225° C. The resulting compound was strand pelletized. The amount of the polymer components forming the blend of comparative examples CE1 and CE2 and the inventive examples IE1 and IE2 are summarized in the following table B. The amount of the blend components are given in % by weight, based on the total weight of the blend.

TABLE B
The relative of the polymers used for
polymer blend (given in % by weight)

| Example | Polyester 1 | Polyester 2 | PLA | PCL 1 |
|---|---|---|---|---|
| CE1 | 40 | 0 | 60 | 0 |
| CE2 | 0 | 40 | 60 | 0 |
| IE1 | 25 | 0 | 60 | 15 |
| IE2 | 0 | 25 | 60 | 15 |

### 3 Examples and Results

### 3.1 Comparative Example CE1

The compounds were applied as a monolayer via the main extruder A. The melt temperature was about 238° C. in both cases.

### 3.2 Comparative Example CE2, Inventive Examples IE1 and IE2

Further paper substrate coatings were carried out in the same way as for the comparative example CE1 with the polymers used and/or the amounts of polymers being varied, as shown in the above table B.

The following table C summarizes further coating conditions and the adhesion results of CE1, CE2, IE1 and IE2. The adhesion was rated with a scale of 1 to 5, wherein 0=“no adhesion”, 1=“a bit sticking”, 2=“some torn fibers”, 3=“under 50% fiber tear”, 4=“over 50% fiber tear”, 4.5=“over 90% fiber tear”, 5=“100% fiber tear; a “perfect” adhesion”.

TABLE C
Coating conditions and adhesion results of CE1, CE2, IE1 and IE2

| | | Coating Weight | Line speed | |
|---|---|---|---|---|
| | Substrate | [g/m²] | [m/min] | Adhesion |
| CE1 | Sappi | 14.7 | 180 | 4 |
| IE1 | Sappi | 15.7 | 180 | 4.5 |
| CE2 | Sappi | 14.2 | 180 | 2 |
| IE2 | Sappi | 14.8 | 200 | 3 |
| CE1 | CFN | 22.7 | 120 | 4 |
| IE1 | CFN | 23.8 | 120 | 5 |

0 = “no adhesion”, 1 = “a bit sticking”, 2 = “some torn fibers”, 3 = “under 50% fiber tear”, 4 = “over 50% fiber tear”, 4.5 = “over 90% fiber tear”, 5 = “100% fiber tear; a “perfect” adhesion”

Moreover, the following table 0 summarizes the coating conditions and the seal strength results of CE1, CE2, IE1 and IE2.

TABLE D
Coating conditions and the seal strength results of CE1, CE2, IE1 and IE2

| | | Coating | Web | | seal strength | seal strength |
|---|---|---|---|---|---|---|
| | | Weight | speed | seal strength | (MD) 120° C. | (MD) 140° C. |
| | Substrate | [g/m²] | [m/min] | (MD) 100° C. | [N/15 mm] | [N/15 mm] |
| CE1 | Sappi | 14.7 | 180 | 4.02 | 3.93 | n.d. |
| CE1 | Sappi | 15.8 | 180 | 3.42 | 3.69 | n.d. |
| CE1 | Sappi | 16.1 | 180 | 3.94 | 3 | n.d. |
| CE1 | Sappi | 15.9 | 180 | 3.96 | 3.43 | n.d. |
| CE1 | Sappi | 15.6 | 180 | 3.84 | 3.51 | n.d. |
| IE1 | Sappi | 15.7 | 180 | 4.52 | 4.8 | n.d. |
| IE1 | Sappi | 15.2 | 180 | 4.04 | 3.71 | n.d. |
| IE1 | Sappi | 15.45 | 180 | 4.28 | 4.26 | n.d. |
| CE1 | CFN | 23.4 | 120 | n.d | 5.42 | 6 |
| CE1 | CFN | 22.7 | 120 | n.d | 4.52 | 4.19 |
| CE1 | CFN | 23.05 | 120 | n.d | 4.97 | 5.095 |
| IE1 | CFN | 23.6 | 120 | n.d | 5.65 | 4.11 |
| IE1 | CFN | 23.8 | 120 | n.d | 5.39 | 6.71 |
| IE1 | CFN | 23.7 | 120 | n.d | 5.52 | 5.41 |
| CE2 | Sappi | 15 | 180 | n.d | 3 | 2.3 |
| CE2 | Sappi | 14.2 | 180 | n.d | 2.53 | 2.72 |
| CE2 | Sappi | 14.6 | 180 | n.d | 2.765 | 2.51 |
| IE2 | Sappi | 14.8 | 200 | n.d | 3.4 | 3.09 |
| IE2 | Sappi | 14.8 | 200 | n.d | 3.4 | 3.09 |
| CE2 | CFN | 22.3 | 150 | n.d | 5.63 | n.d |
| IE2 | CFN | 25.7 | 120 | n.d | 5.78 | 5.01 |

n.d. = “not determined”
MD = machine direction

### 3.3 Comparative Example CE3 and Inventive Examples IE3 and IE4

To investigate the effect of the PLA content on the processability on the extrusion coating line, extrusion coating was carried out with polyester 1, PLA and PCL 1 or 2, wherein the amount of single component was varied. The weight ratio of the used components and the resulting maximum line speeds are summarized in the following table.

TABLE E
The weight ratios of the polymers used in
CE3, IE3 and IE4 (given in % by weight)

| | Polyester 1 | PLA | PCL | max. line speed [m/min] |
|---|---|---|---|---|
| CE3 | 80 | 10 | 10 | Extrusion coating not possible |
| IE3 | 40 | 48 | 12 | 120 |
| IE4 | 25 | 60 | 15 | 360 |

It was shown that relatively high PLA content was needed for processability on extrusion coating line.

### 3.4 Inventive Examples IE5, IE6 and IE7

To investigate the effect of the viscosity number of PCL on the processability on the extrusion coating line, extrusion coating was carried out with polyester 1, PLA and PCL 1 and 3, wherein the amount of single component was varied. The weight ratios of the used components and the resulting maximum line speeds are summarized in the following table.

TABLE F
The weight ratios of the polymers used in
IE5, IE6 and IE7 (given in % by weight)

| | Polyester 1 | PLA | PCL | max. line speed [m/min] |
|---|---|---|---|---|
| IE5 | 40 | 48 | 12 (PCL 1) | 120 |
| IE6 | 25 | 60 | 15 (PCL 3) | 220 |
| IE7 | 25 | 60 | 15 (PCL 1) | 360 |

### 3.5 Comparative Example CE4 and Inventive Example IE8

The following blends were produced as described above and are particularly suitable for producing rigid packaging by injection molding of the blend.

TABLE A
Composition of the polymer blend for injection
molding (given in % by weight)

| Example | PLA | Polyester 1 | PCL 1 | Filler | Additive |
|---|---|---|---|---|---|
| IE8 | 42 | 17 | 10.5 | 30 | 0.5 |
| CE4 | 55 | 14.5 | 0 | 30 | 0.5 |

TABLE C
Properties of the polymer blends prepared
for injection molding applications

| | MVR (190° C., 2.16 kg) | | |
|---|---|---|---|
| Example | [mL/10 min] | E [MPa] | HDT/B [° C.] |
| IE8 | 5.0 | 5064 | 55.1 |
| CE4 | 6.9 | 3210 | 57.1 |

As shown, introduction of PCL increases stiffness without drastically affecting other properties such as heat stability and flowability. Therefore, the blends are particularly suitable for producing rigid packaging.

1.-18. (canceled)

19. A biodegradable polymer blend comprising
10 to 80% by weight, based on the total weight of polyester a), polymer b) and polycaprolactone c), of at least one biodegradable polyester a) selected from the group consisting of aliphatic-aromatic polyesters, aliphatic polyesters, which are different from polymers b) and c), and mixtures thereof;
18 to 88% by weight, based on the total weight of polyester a), polymer b) and polycaprolactone c), of at least one polymer b), selected from the group consisting of polyhydroxyalkanoates, polylactides, polyglycolic acid and mixtures thereof;
2 to 72% by weight, based on the total weight of polyester a), polymer b) and polycaprolactone c), of at least one polycaprolactone c) having a viscosity number of at least 110 ml/g, as determined according to DIN 53728-3:1985-1;
wherein the total weight of polyester a), polymer b) and polycaprolactone c) is at least 50% by weight, based on the total weight of the blend.

20. The biodegradable polymer blend according to claim 19, wherein the weight ratio of polyester a) to the sum of polymer b) and polycaprolactone c) is in the range of 10:90 to 80:20.

21. The biodegradable polymer blend according to claim 19, wherein the weight ratio of polymer b) to polycaprolactone c) is in the range of 9:1 to 1:4.

22. The biodegradable polymer blend according to claim 19, wherein the amount of polyester a) is in the range of 15 to 50% by weight, the amount of polymer b) is in the range of 35 to 70% by weight, and the amount of the polycaprolactone c) is in the range of 5 to 50% by weight, based on the total weight of polyester a), polymer b) and polycaprolactone c).

23. The biodegradable polymer blend according to claim 19, wherein the number average molecular weight of the polycaprolactone c) is at least 20000 g/mol, as determined by GPC.

24. The biodegradable polymer blend according to claim 19, wherein polyester a) has a melt volume rate (MVR) according to EN ISO 1133 (190° C., 2.16 kg weight) in the range of 0.5 to 70 cm³/10 min.

25. The biodegradable polymer blend according to claim 19, having a melt volume rate (MVR) in the range of 1 to 35 cm³/10 min according EN ISO 1133 (190° C., 2.16 kg weight).

26. The biodegradable polymer blend according to claim 19, wherein polymer b) is selected from the group consisting of polylactides.

27. The biodegradable polymer blend according to claim 19, wherein polyester a) is selected from the group consisting of poly(butylene adipate-co-terephthalate), poly(butylene sebacate-co-terephthalate), poly(butylene azelate-co-terephthalate), poly(butylene succinate-co-terephthalate), poly(butylene adipate-co-sebacate-co-terephthalate), poly(butylene adipate-co-azelate-co-terephthalate), poly(butylene adipate-co-succinate-co-terephthalate), poly(butylene sebacate-co-azelate-co-terephthalate), poly(butylene sebacate-co-succinate-co-terephthalate), poly(butylene azelate-co-succinate-co-terephthalate), poly(butylene adipate-co-furanoate), poly(butylene sebacate-co-furanoate), poly(butylene azelate-co-furanoate), poly(butylene succinate-co-furanoate), poly(butylene adipate-co-sebacate-co-furanoate), poly(butylene adipate-co-azelate-co-furanoate), poly(butylene adipate-co-succinate-co-furanoate), poly(butylene sebacate-co-azelate-co-furanoate), poly(butylene sebacate-co-succinate-co-furanoate), poly(butylene azelate-co-succinate-co-furanoate), poly(butylene succinate), poly(butylene succinate-co-adipate), poly(butylene succinate-co-sebacate) and mixtures thereof.

28. A mono-layered or multi-layered film comprising at least one layer comprising the biodegradable polymer blend according to claim 19.

29. A method comprising coating a substrate layer with the biodegradable polymer blend according to claim 19.

30. A process for coating a substrate layer, comprising steps:
step A) providing a substrate layer, and
step B) coating the substrate with one or more polymer layers, where at least one polymer layer comprises or consists of the biodegradable polymer blend according to claim 19.

31. The process according to claim 30, wherein the coating in step B) is carried out by extrusion coating, coextrusion coating, lamination with mono- or multilayer film or thermoforming.

32. The process according to claim 30, wherein the substrate layer is a fiber-based substrate, such as paper, cardboard, paperboard or fiber board.

33. A laminate comprising at least one film according to claim 28 and a substrate onto which the film is laminated.

34. A laminate, which is obtained by the process according to claim 30.

35. A material, which is selected from packaging; paper and cardboard cups and plates; carrier bags; paper adhesive tape; paper labels; flower pots; and plant pots, where the material comprises at least one film according to claim 28.

36. A method for producing rigid packaging articles which comprises shaping a polymer blend according to claim 19 by thermoforming or injection molding.
